(19) United States
(12) Patent Application Publication
(10) Pub. No.: US 2009/0148038 A1
(43) Pub. Date: Jun. 11, 2009

(54) DISTANCE IMAGE PROCESSING APPARATUS AND METHOD

(76) Inventor: Youichi SAWACHI, Kurokawa-gun (JP)

Correspondence Address: BIRCH STEWART KOLASCH & BIRCH, PO BOX 747, FALLS CHURCH, VA, 22040-0747, US

(21) Appl. No.: 12/331,132

(22) Filed: Dec. 9, 2008

(30) Foreign Application Priority Data
Dec. 10, 2007 (JP) 318068/2007
Dec. 10, 2007 (JP) 318069/2007
Dec. 10, 2007 (JP) 318070/2007
Dec. 10, 2007 (JP) 318071/2007
Dec. 10, 2007 (JP) 318072/2007

(51) Int. Cl. G06K 9/00

(52) U.S. Cl. 382/154

(57) ABSTRACT

A distance image processing apparatus including a distance image obtaining unit for obtaining distance values that include depth information and position information, and represent a three-dimensional shape of a subject obtained by photographing the subject, a conversion unit for converting the depth information with a quantization number such that the smaller the depth information the larger the quantization number, and an image file generation unit for generating an image file of a distance image with distance values that include the converted depth information as the pixel value of each pixel, the image file including information related to the conversion attached thereto.

### BACKGROUND OF THE INVENTION

1. Field of the Invention

The present invention relates to a distance image processing apparatus and method for processing distance values that include depth information and position information, and represent a three-dimensional shape of a subject, and a distance image reproducing apparatus and method for reproducing a processed distance image. The invention also relates to a computer readable recording medium on which is recorded a program for causing a computer to perform the distance image processing method or the distance image reproducing method.

2. Description of the Related Art

A method for generating a distance image that represents a three-dimensional shape of a subject is proposed. In the method, the subject is imaged by two or more cameras placed at different positions, then corresponding points, which are pixels corresponding to each other, between a plurality of images (a base image obtained by a base camera and a reference image obtained by a reference camera) obtained by the imaging are searched for (stereo matching) to calculate the positional difference (parallax) between the pixel in the base image and the pixel in the reference image corresponding to each other, and the distance from the base camera or reference camera to the point on the subject corresponding to the pixel is measured by applying the principle of triangulation to the parallax, whereby the distance image is generated. Further, a method for embedding such a distance image in a base image which is before the distance calculation is performed to generate a single image file is proposed as described, for example, in Japanese unexamined Patent Publication No. 2005-077253. Still further, a method for correcting positional displacement between the base image and distance image is also proposed as described, for example, in Japanese Unexamined Patent Publication No. 2000-131035.

Further, a method for measuring the distance from a photographing apparatus to a subject by a TOF (Time of Flight) distance measurement method, in which the distance to a subject is measured by making use of the reflection of light in order to generate a distance image representing a three-dimensional shape of a subject is proposed as described, for example, in Japanese Unexamined Patent Publication No. 2006-084429. More specifically, the TOF distance measurement method generates a distance image in the following manner. That is, intensity-modulated measuring light is irradiated toward a subject and reflection light is received at four phases of 0, π/2, π, and 3π/2 in the modulation period to obtain a light receiving signal according to the received amount of light, then a phase delay (phase difference) between the measuring light and reflection light is detected by each of light receiving elements of an imaging device provided in the photographing apparatus to calculate distance information, and a distance image representing a three-dimensional shape of the subject is generated with the distance information as the pixel value of each pixel.

In the mean time, when generating a distance image, it is necessary to calculate a distance value representing the distance to a subject by the stereo matching method or TOF method described above. Here, the distance value must accurately represent the distance to the subject. Consequently, the number of bits of the distance value becomes very large, such as 32 bits or the like. Accordingly, the amount of data of a distance image file also becomes very large and, as the result, the number of files of distance images recordable on a recording medium is reduced.

### SUMMARY OF THE INVENTION

The present invention has been developed in view of the circumstances described above, and it is a first object of the present invention to enable an efficient reduction in the amount of data for an image file of a distance image.

It is a second object of the present invention to easily enable a reverse conversion of an image file of a distance image converted such that the amount of data thereof is reduced.

A first distance image processing apparatus according to the present invention is an apparatus including:

a distance value obtaining means for obtaining distance values that include depth information and position information, and represent a three-dimensional shape of a subject obtained by photographing the subject;

a conversion means for converting the depth information with a quantization number such that the smaller the depth information the larger the quantization number; and

an image file generation means for generating an image file of a distance image with distance values that include the converted depth information as the pixel value of each pixel, the image file including information related to the conversion attached thereto.

“Information related to the conversion” is information indicating that a distance value is converted and may include, for example, information whether or not conversion is performed, and information regarding the quantization number and the like when converted. The information related to the conversion may be attached to the image file by describing it in the header of the image file or by describing it in a text file separate from the image file and inseparably linked to the image file. Further, changing the extension of the image file to indicate that a distance value is converted is also included in the scope of attaching the information related to the conversion in the present application.

In the first distance image processing apparatus of the present invention, the conversion means may be a means that sets the quantization number to a larger value for depth information smaller than or equal to a first threshold value than a value for depth information exceeding the first threshold value.

Further, in the first distance image processing apparatus of the present invention, the conversion means may be a means capable of setting the first threshold value.

In this case, the conversion means may be a means capable of setting the first threshold value according to distance information representing the distance to the subject.

As for the “distance information representing the distance to the subject”, depth information included in the distance values obtained by the distance value obtaining means may be used. Alternatively, the apparatus may further include another means capable of measuring the distance to the subject and the distance to the subject measured by the means may be used. As for another means, in particular, an AF means that focuses on the subject which is used when obtaining the distance value using an image obtained by photographing a subject, a means that emits a flash of light onto a subject and measures the distance to the subject based on the amount of reflected light, or the like may be used. When photographing a subject, an imaging mode may be set. In this case, there may be a case in which the distance to the subject may be estimated based on the imaging mode. For example, in the case of macro mode, short-range photographing for a subject is performed, thus the distance to the subject is short. Accordingly the “distance information representing the distance to the subject” in the present invention includes information of imaging mode selected at the time of photographing that allows estimation of the distance to the subject.

Still further, in the first distance image processing apparatus of the present invention, the image file generation means may be a means that attaches information of the first threshold value and quantization number at the first threshold value to the image file as the information related to the conversion.

Further, in the first distance image processing apparatus of the present invention, the conversion means may be a means that converts the depth information based on a predetermined continuously changing relationship between the depth information and quantization number.

Still further, in the first distance image processing apparatus of the present invention, the image file generation means may be a means that attaches information of the relationship to the image file as the information related to the conversion.

Further, in the first distance image processing apparatus of the present invention, the conversion means may be a means capable of setting the quantization number for the depth information after converted.

Still further, in the first distance image processing apparatus of the present invention, the conversion means may be a means that accepts an instruction to convert the depth information and converts the depth information only when the instruction is given.

Further, in the first distance image processing apparatus of the present invention, when the depth information is larger than a second threshold value:

the conversion means may be a means that converts the position information such that the closer the position information to the center of a distance image with the distance values as the pixel value of each pixel the larger the quantization number; and

the image file generation means may be a means that generates an image file of a distance image with distance values that include the converted position information as the pixel value of each pixel.

Still further, in the first distance image processing apparatus of the present invention, the conversion means may be a means that sets the quantization number to a larger value for position information in a predetermined area of the distance image including the center thereof than a value for position information outside of the predetermined area.

Further, in the first distance image processing apparatus of the present invention, the image file generation means may be a means that attaches information of the boundary of the predetermined area and quantization number at the boundary to the image file as the information related to the conversion.

Still further, in the first distance image processing apparatus of the present invention, the conversion means may be a means capable of setting the second threshold value.

In this case, the conversion means may be a means capable of setting the second threshold value according to distance information representing the distance to the subject.

Further, in the first distance image processing apparatus of the present invention, the conversion means may be a means capable of setting the quantization number for the position information after converted.

Still further, in the first distance image processing apparatus of the present invention, the conversion means may be a means that accepts an instruction to convert the position information and converts the position information only when the instruction is given.

A first distance image reproducing apparatus according to the present invention is an apparatus, including

an image file obtaining means for obtaining an image file generated by the first distance image processing apparatus according to the present invention; and

a reverse conversion means for obtaining the information related to the conversion attached to the image file and reversely converting the converted depth information included in the image file based on the information.

In the first distance image reproducing apparatus of the present invention, when position information included in the distance values is converted, the reverse conversion means may be a means that obtains the information related to the conversion attached to the image file and reversely converting the converted depth information and position information included in the image file based on the information.

A first distance image processing method according to the present invention is a method including the steps of:

obtaining distance values that include depth information and position information, and represent a three-dimensional shape of a subject obtained by photographing the subject;

converting the depth information with a quantization number such that the smaller the depth information the larger the quantization number; and

generating an image file of a distance image with distance values that include the converted depth information as the pixel value of each pixel, the image file including information related to the conversion attached thereto.

In the first distance image processing method of the present invention, when the depth information is larger than a second threshold value, the method may include the steps of:

converting the position information such that the closer the position information to the center of a distance image with the distance values as the pixel value of each pixel the larger the quantization number; and

generating an image file of a distance image with distance values that include the converted position information as the pixel value of each pixel.

A first distance image reproducing method according to the present invention is a method including the steps of:

obtaining an image file generated by the first distance image processing method;

obtaining the information related to the conversion attached to the image file; and

reversely converting the converted depth information included in the image file based on the information.

In the first distance image reproducing method, when position information included in the distance values is converted, the method may include the steps of:

obtaining the information related to the conversion attached to the image file; and

reversely converting the converted depth information and position information included in the image file based on the information.

Each of the first distance image processing method and the first distance image reproducing method according to the present invention may be supplied as a program recorded on a computer readable recording medium for causing a computer to perform the method.

According to the first distance image processing apparatus and method of the present invention, depth information is quantized with a quantization number such that the smaller the depth information the larger the quantization number, and an image file of a distance image with distance values that include the converted depth information as the pixel value of each pixel is generated. Here, when calculating a distance value, the calculation accuracy is degraded more for larger depth information, that is, a farther away distance. According to the present invention, the depth information is quantized with a quantization number such that the smaller the depth information the larger the quantization number, so that the amount of data of the image file of the distance image may be reduced efficiently without degrading distance accuracy for relatively small depth information.

Further, the calculation accuracy is degraded more for position information closer to an edge portion of a distance image with distance values as the pixel value of each pixel due to properties and shading of the lenses of imaging units that obtain images for calculating the distance values. Consequently, by setting a larger quantization number for position information closer to the center of the distance image, the amount of data of the image file of the distance image may be reduced further efficiently without degrading distance accuracy near the center of the distance image.

Still further, by allowing the first or second threshold value to be settable according to distance information representing the distance to a subject, the threshold value for changing the quantization number may be set appropriately according to the distance to the subject.

Further, by allowing the quantization number to be settable for depth information and/or position information, the depth information and/or position information may be quantized with a desired quantization number.

Still further, by converting depth information and/or position information only when an instruction to convert the depth information and/or position information is given, depth information and/or position information may be converted only when desired, so that wasteful processing may be prevented.

A second distance image processing apparatus according to the present invention is an apparatus, including:

a distance value obtaining means for obtaining distance values that include depth information and position information, and represent a three-dimensional shape of a subject obtained by photographing the subject;

a conversion means for converting, when the depth information is larger than a first threshold value, the position information with a quantization number such that the closer the position information to the center of a distance image with the distance values as the pixel value of each pixel the larger the quantization number; and

an image file generation means for generating an image file of a distance image formed of distance values that include the converted position information, the image file including information related to the conversion attached thereto.

“Information related to the conversion” is information indicating that a distance value is converted and may include, for example, information whether or not conversion is performed, and information regarding the quantization number and the like when converted. The information related to the conversion may be attached to the image file by describing it in the header of the image file or by describing it in a text file separate from the image file and inseparably linked to the image file. Further, changing the extension of the image file to indicate that a distance value is converted is also included in the scope of attaching the information related to the conversion in the present application.

In the second distance image processing apparatus of the present invention, the conversion means may be a means that sets the quantization number to a larger value for position information in a predetermined area of the distance image including the center thereof than a value for position information outside of the predetermined area.

Further, in the second distance image processing apparatus of the present invention, the image file generation means may be a means that attaches information of the boundary of the predetermined area and quantization number at the boundary to the image file as the information related to the conversion.

Still further, in the second distance image processing apparatus of the present invention, the conversion means may be a means capable of setting the first threshold value.

In this case, the conversion means may be a means capable of setting the first threshold value according to distance information representing the distance to the subject.

Further, in the second distance image processing apparatus of the present invention, the conversion means may be a means capable of setting the quantization number for the position information after converted.

Still further, in the second distance image processing apparatus of the present invention, the conversion means may be a means that accepts an instruction to convert the position information and converts the position information only when the instruction is given.

A second distance image reproducing apparatus according to the present invention is an apparatus, including:

an image file obtaining means for obtaining an image file generated by the second distance image processing apparatus according to the present invention; and

a reverse conversion means for obtaining the information related to the conversion attached to the image file and reversely converting the converted position information included in the image file based on the information.

A second distance image processing method according to the present invention is a method, including the steps of:

obtaining distance values that include depth information and position information, and represent a three-dimensional shape of a subject obtained by photographing the subject;

converting, when the depth information is larger than a first threshold value, the position information with a quantization number such that the closer the position information to the center of a distance image with the distance values as the pixel value of each pixel the larger the quantization number; and

generating an image file of a distance image formed of distance values that include the converted position information.

A second distance image reproducing method according to the present invention is a method, including the steps of:

obtaining an image file generated by the second distance image processing method according to the present invention;

obtaining the information related to the conversion attached to the image file; and

reversely converting the converted position information included in the image file based on the information.

Each of the second distance image processing method and the second distance image reproducing method according to the present invention may be supplied as a program recorded on a computer readable recording medium for causing a computer to perform the method.

According to the second distance image processing apparatus and method, when depth information is larger than a first threshold value, position information is converted with a quantization number such that the closer the position information to the center of the distance image the larger the quantization number, and an image file of a distance image formed of distance values that include the converted position information is generated.

Here, when calculating a distance value, the calculation accuracy is degraded more for position information closer to an edge portion of a distance image with distance values as the pixel value of each pixel due to properties and shading of the lenses of imaging units that obtain images for calculating the distance values. Consequently, by setting a larger quantization number for position information closer to the center of the distance image, the amount of data of the image file of the distance image may be reduced further efficiently without degrading distance accuracy near the center of the distance image.

Further, by allowing the first threshold value to be settable according to distance information representing the distance to a subject, the threshold value for changing the quantization number may be set appropriately according to the distance to the subject.

Still further, by allowing the quantization number to be settable for position information, the position information may be quantized with a desired quantization number.

Further, by converting position information only when an instruction to convert the position information is given, position information may be converted only when desired, so that wasteful processing may be prevented.

A third distance image processing apparatus according to the present invention is an apparatus, including:

a distance value obtaining means for obtaining distance values that include depth information and position information, and represent a three-dimensional shape of a subject obtained by photographing the subject;

a conversion means for converting depth information in a predetermined range with a larger quantization number than that of depth information outside of the predetermined range; and

an image file generation means for generating an image file of a distance image with distance values that include the converted depth information as the pixel value of each pixel, the image file including information related to the conversion attached thereto.

“Information related to the conversion” is information indicating that a distance value is converted and may include, for example, information whether or not conversion is performed, and information regarding the quantization number and the like when converted. The information related to the conversion may be attached to the image file by describing it in the header of the image file or by describing it in a text file separate from the image file and inseparably linked to the image file. Further, changing the extension of the image file to indicate that a distance value is converted is also included in the scope of attaching the information related to the conversion in the present application.

In the third distance image processing apparatus of the present invention, the conversion means may be a means that generates a distance histogram representing frequency of the depth information in the depth direction and sets the predetermined range based on the distance histogram.

Further, in the third distance image processing apparatus of the present invention, the image file generation means may be a means that attaches information of upper and lower limits of the predetermined range and quantization numbers at the upper and lower limits to the image file as the information related to the conversion.

Still further, in the third distance image processing apparatus of the present invention, the conversion means may be a means capable setting the quantization number of the depth information after converted.

Further, in the third distance image processing apparatus of the present invention, the conversion means may be a means that accepts an instruction to convert the depth information and converts the depth information only when the instruction is given.

Still further, in the third distance image processing apparatus of the present invention, when the depth information is larger than a first threshold value:

the conversion means may be a means that converts the position information such that the closer the position information to the center of a distance image with the distance values as the pixel value of each pixel the larger the quantization number; and

the image file generation means may be a means that generates an image file of a distance image with distance values that include the converted position information as the pixel value of each pixel.

Further, in the third distance image processing apparatus of the present invention, the conversion means may be a means that sets the quantization number to a larger value for position information in a predetermined area of the distance image including the center thereof than a value for position information outside of the predetermined area.

Still further, in the third distance image processing apparatus of the present invention, the image file generation means may be a means that attaches information of the boundary of the predetermined area and quantization number at the boundary to the image file as the information related to the conversion.

Further, in the third distance image processing apparatus of the present invention, the conversion means may be a means capable of setting the first threshold value.

In this case, the conversion means may be a means capable of setting the first threshold value according to distance information representing the distance to the subject.

Still further, in the third distance image processing apparatus of the present invention, the conversion means may be a means capable of setting the quantization number of the position information after converted.

Further, in the third distance image processing apparatus of the present invention, the conversion means may be a means that accepts an instruction to convert the position information and converts the position information only when the instruction is given.

A third distance image reproducing apparatus according to the present invention is an apparatus, including:

an image file obtaining means for obtaining an image file generated by the third distance image processing apparatus according to the present invention; and

a reverse conversion means for obtaining the information related to the conversion attached to the image file and reversely converting the converted depth information included in the image file based on the information.

In the third distance image reproducing apparatus of the present invention, when position information included in the distance values is converted, the reverse conversion means may be a means that obtains the information related to the conversion attached to the image file and reversely converting the converted depth information and position information included in the image file based on the information.

A third distance image processing method according to the present invention is a method, including the steps of:

obtaining distance values that include depth information and position information, and represent a three-dimensional shape of a subject obtained by photographing the subject;

converting depth information in a predetermined range with a larger quantization number than that of depth information outside of the predetermined range; and

generating an image file of a distance image with distance values that include the converted depth information as the pixel value of each pixel, the image file including information related to the conversion attached thereto.

In the third distance image processing method of the present invention, when the depth information is larger than a first threshold value, the method may include the steps of:

converting the position information such that the closer the position information to the center of a distance image with the distance values as the pixel value of each pixel the larger the quantization number; and

generating an image file of a distance image with distance values that include the converted position information as the pixel value of each pixel.

A third distance image reproducing method according to the present invention is a method, including the steps of:

obtaining an image file generated by the third distance image processing method according to the present invention;

obtaining the information related to the conversion attached to the image file; and

reversely converting the converted depth information included in the image file based on the information.

In the third distance image reproducing method of the present invention, when position information included in the distance values is converted, the method may include the steps of:

obtaining the information related to the conversion attached to the image file; and

reversely converting the converted depth information and position information included in the image file based on the information.

Each of the third distance image processing method and the third distance image reproducing method according to the present invention may be supplied as a program recorded on a computer readable recording medium for causing a computer to perform the method.

According to the third distance image processing apparatus and method of the present invention, depth information in a predetermined range is converted with a larger quantization number than that of depth information outside of the predetermined range, and an image file of a distance image with distance values that include the converted depth information as the pixel value of each pixel is generated. Here, when photographing a subject, it is often the case that the subject is present in a certain distance range.

Consequently, by increasing the quantization number for depth information in a predetermined range, the amount of data of an image file of a distance image may be reduced efficiently without degrading distance accuracy in the predetermined range.

Further, the calculation accuracy is degraded more for position information closer to an edge portion of a distance image with distance values as the pixel value of each pixel due to properties and shading of the lenses of imaging units that obtain images for calculating the distance values. Consequently, by setting a larger quantization number for position information closer to the center of the distance image, the amount of data of the image file of the distance image may be reduced further efficiently without degrading distance accuracy near the center of the distance image.

Still further, by allowing the first threshold value to be settable according to distance information representing the distance to a subject, the threshold value for changing the quantization number may be set appropriately according to the distance to the subject.

Further, by allowing the quantization number to be settable for depth information and/or position information, the depth information and/or position information may be quantized with a desired quantization number.

Still further, by converting depth information and/or position information only when an instruction to convert the depth information and/or position information is given, depth information and/or position information may be converted only when desired, so that wasteful processing may be prevented.

A fourth distance image processing apparatus according to the present invention is an apparatus, including:

a distance value obtaining means for obtaining distance values that include depth information and position information, and represent a three-dimensional shape of a subject obtained by photographing the subject;

a conversion means for converting at least either of the depth information and position information by a selected one of a plurality of predetermined quantization methods; and

an image file generation means for generating an image file of a distance image with distance values that include at least either of the converted depth information and position information as the pixel value of each pixel, the image file including information related to the conversion attached thereto.

“Information related to the conversion” is information indicating that a distance value is converted and may include, for example, information whether or not conversion is performed, and information regarding the quantization number and the like when converted. The information related to the conversion may be attached to the image file by describing it in the header of the image file or by describing it in a text file separate from the image file and inseparably linked to the image file. Further, changing the extension of the image file to indicate that a distance value is converted is also included in the scope of attaching the information related to the conversion in the present application.

In the fourth distance image processing apparatus of the present invention, the conversion means may be a means that converts the depth information by a selected one of a plurality of quantization methods that quantizes the depth information with a quantization number such that the smaller the depth information the larger the quantization number.

Further, in the fourth distance image processing apparatus of the present invention, the conversion means may be a means that converts the position information by a selected one of a plurality of quantization methods that quantizes the position information with a quantization number such that the closer the position information to the center of a distance image with the distance values as the pixel value of each pixel the larger the quantization number.

Still further, in the fourth distance image processing apparatus of the present invention, the conversion means may be a means that converts the depth information by a selected one of a plurality of quantization methods that quantizes depth information in a predetermined range with a larger quantization number than that of depth information outside of the predetermined range.

Further, the fourth distance image processing apparatus of the present invention may further include a selection means for accepting selection of a desired one of the plurality of quantization methods.

A fourth distance image reproducing apparatus according to the present invention is an apparatus, including:

an image file obtaining means for obtaining an image file generated by the fourth distance image processing apparatus according to the present invention; and

a reverse conversion means for obtaining the information related to the conversion attached to the image file and reversely converting at least either of the converted depth information and position information included in the image file based on the information.

A fourth distance image processing method according to the present invention is a method, including the steps of:

obtaining distance values that include depth information and position information, and represent a three-dimensional shape of a subject obtained by photographing the subject;

converting at least either of the depth information and position information by a selected one of a plurality of predetermined quantization methods; and

generating an image file of a distance image with distance values that include at least either of the converted depth information and position information as the pixel value of each pixel, the image file including information related to the conversion attached thereto.

A fourth distance image reproducing method according to the present invention is a method, including the steps of:

obtaining an image file generated by the fourth distance image processing apparatus according to the present invention;

obtaining the information related to the conversion attached to the image file; and

reversely converting at least either of the converted depth information and position information included in the image file based on the information.

Each of the fourth distance image processing method and the fourth distance image reproducing method according to the present invention may be supplied as a program recorded on a computer readable recording medium for causing a computer to perform the method.

According to the fourth distance image processing apparatus and method of the present invention, at least either of depth information and position information is converted by a selected one of a plurality of predetermined quantization methods, and an image file of a distance image with distance values that include at least either of the converted depth information and position information as the pixel value of each pixel is generated. This allows the user of the present invention to convert a distance image by a desired quantization method, thereby reducing the amount of data of the image file of the distance image as desired.

A fifth distance image reproducing apparatus according to the present invention is an apparatus, including:

an image file obtaining means for obtaining an image file of a distance image generated by converting distance values that include depth information and position information, and represent a three-dimensional shape of a subject such that the amount of data thereof is reduced, the distance image being formed with the distance values reduced in the amount of data as the pixel value of each pixel, and the image file including information related to the conversion attached thereto; and

a reverse conversion means for obtaining the information related to the conversion attached to the image file and reversely converting the distance values included in the image file based on the information.

“Information related to the conversion” is information indicating that a distance value is converted and may include, for example, information whether or not conversion is performed, and information regarding the quantization number and the like when converted. The information related to the conversion may be attached to the image file by describing it in the header of the image file or by describing it in a text file separate from the image file and inseparably linked to the image file. Further, changing the extension of the image file to indicate that a distance value is converted is also included in the scope of attaching the information related to the conversion in the present application.

In the fifth distance image reproducing apparatus of the present invention, when the distance values are converted by quantizing at least either of the depth information and position information by a predetermined quantization method, the reverse conversion means may be a means that reversely converts at least either of the converted depth information and position information included in the image file based on the information.

A fifth distance image reproducing method according to the present invention is a method, including the steps of:

obtaining an image file of a distance image generated by converting distance values that include depth information and position information, and represent a three-dimensional shape of a subject such that the amount of data thereof is reduced, the distance image being formed with the distance values reduced in the amount of data as the pixel value of each pixel, and the image file including information related to the conversion attached thereto;

obtaining the information related to the conversion attached to the image file; and

reversely converting the distance values included in the image file based on the information.

The fifth distance image reproducing method according to the present invention may be supplied as a program recorded on a computer readable recording medium for causing a computer to perform the method.

According to the fifth distance image reproducing apparatus and method of the present invention, an image file of a distance image generated by converting distance values that include depth information and position information, and represent a three-dimensional shape of a subject such that the amount of data thereof is reduced is obtained, in which the distance image is formed with the distance values reduced in the amount of data as the pixel value of each pixel, and the image file includes information related to the conversion attached thereto, then the information related to the conversion attached to the image file is obtained, and the distance values included in the image file are reversely converted based on the information. In this way, by referring to the information related to the conversion, the image file of the distance image reduced in the amount of data may be reversely converted with ease, whereby the image file of the distance image reduced in the amount of data may be reproduced easily.

### BRIEF DESCRIPTION OF THE DRAWINGS

FIG. 1 is a schematic block diagram of a distance measuring system to which a distance image processing apparatus according to a first embodiment of the present invention is applied, illustrating an internal configuration thereof.

FIG. 2 illustrates a configuration of the imaging unit.

FIG. 3 illustrates a stereo matching method.

FIG. 4 illustrates the positional relationship between a base image and a reference image after parallelized.

FIG. 5 illustrates allocation of quantization number.

FIG. 6 illustrates the relationship between distance value Z and distance value Zti obtained by quantization in the first embodiment.

FIG. 7 illustrates the relationship between distance value X and distance value Xti obtained by quantization.

FIG. 8 is a flowchart illustrating processing performed in the first embodiment.

FIG. 9 illustrates a file structure of an image file obtained by the first embodiment.

FIG. 10 illustrates the relationship between distance value Z and distance value Zti obtained by quantization in a second embodiment.

FIG. 11 is a flowchart illustrating processing performed in the second embodiment.

FIG. 12 illustrates a file structure of an image file obtained by the second embodiment

FIG. 13 illustrates the relationship between distance value X and distance value Xti obtained by quantization in a third embodiment.

FIG. 14 is a flowchart illustrating processing performed in the third embodiment.

FIG. 15 is a flowchart illustrating processing performed in a fourth embodiment.

FIG. 16 illustrates a distance histogram.

FIG. 17 illustrates the relationship between distance value Z and distance value Zti obtained by quantization in the fourth embodiment.

FIG. 18 is a flowchart illustrating quantization processing by mode a.

FIG. 19 is a flowchart illustrating quantization processing by mode b.

FIG. 20 is a flowchart illustrating quantization method selection processing in a fifth embodiment.

FIGS. 21A, 21B illustrate quantization method selection screens.

FIG. 22 is a flowchart illustrating processing performed in the fifth embodiment.

FIG. 23 is a flowchart illustrating inverse quantization processing of an image file generated by the first embodiment.

FIG. 24 is a flowchart illustrating inverse quantization processing of an image file generated by the second embodiment.

### DESCRIPTION OF THE PREFERRED EMBODIMENTS

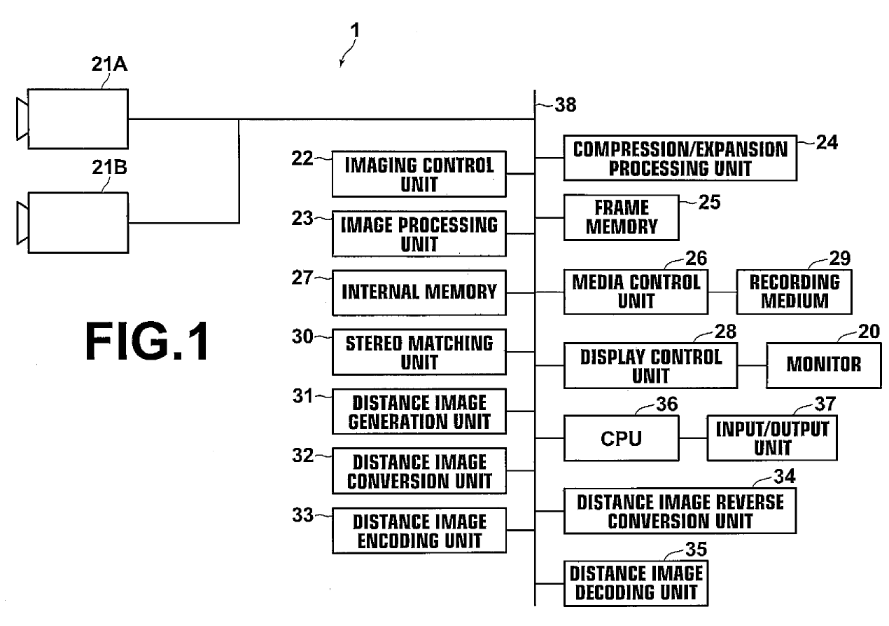

Hereinafter, exemplary embodiments of the present invention will be described with reference to the accompanying drawings. FIG. 1 is a schematic block diagram of a distance measuring system to which the distance image processing apparatus according to a first embodiment of the present invention is applied, illustrating the internal configuration thereof. As illustrated in FIG. 1, distance measuring system 1 according to the first embodiment includes two imaging units 21A, 21B, imaging control unit 22, image processing unit 23, compression/expansion processing unit 24, frame memory 25, media control unit 26, internal memory 27, and display control unit 28.

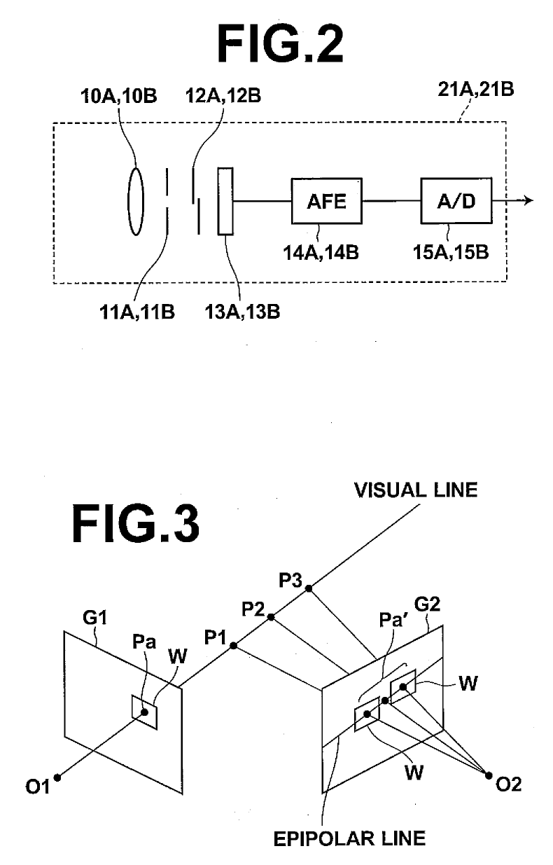

FIG. 2 illustrates a configuration of imaging units 21A, 21B. As illustrated in FIG. 2, imaging units 21A, 21B include lenses 10A, 10B, apertures 11A, 11B, shutters 12A, 12B, CCDs 13A, 13B, analog front ends (AFE) 14A, 14B, and A/D conversion units 15A, 15B respectively.

Each of lenses 10A, 10B includes a plurality of functional lenses, such as a focus lens for bringing a subject into focus, a zoom lens for realizing a zoom function and the like, and positions of the lenses are controlled by a not shown lens drive unit. In the present embodiment, the focal position is assumed to be fixed.

The aperture diameter of each of apertures 11A, 11B is controlled by a not shown aperture drive unit based on the aperture data obtained by AE processing. In the present embodiment, the aperture data are assumed to be fixed.

Each of shutters 12A, 12B is a mechanical shutter and driven by a not shown shutter drive unit according to the shutter speed obtained by AE processing. In the present embodiment, the shutter speed is assumed to be fixed.

Each of CCDs 13A, 13B includes a photoelectric surface having multitudes of light receiving elements disposed two-dimensionally, and a light image representing a subject is formed on the photoelectric surface and subjected to photoelectric conversion, whereby an analog image signal is obtained. A color filter having R, G, and B filters disposed regularly is provided in front of each of CCDs 13A, 13B.

AFEs 14A, 14B perform processing on the analog image signals outputted from CCDs 13A, 13B respectively for removing noise and adjusting gain (analog processing).

A/D conversion units 15A, 15B convert the analog image signals analog-processed by AFEs 14A, 14B respectively. Image data obtained by converting the analog image signals obtained by CCDs 13A, 13B of imaging units 21A, 21B are RAW data in which each pixel has R, G, and B density values. An image represented by image data obtained by imaging unit 21A is referred to as base image G1, and an image represented by image data obtained by imaging unit 21B is referred to as reference image G2.

Imaging control unit 22 controls imaging after the release button is depressed.

In the present embodiment, the focal position, aperture data, and shutter speed are fixed, but they may be set for each imaging by performing AF processing and AE processing. In this case, a table including standard values with respect to the focal position, aperture data, and shutter speed, and different focal positions, aperture data, and shutter speeds depending on the distance to the subject and brightness of photographing environment may be stored in internal memory 27 in advance, and the focal position, aperture data, and shutter speed may be set according to the distance to the subject and brightness of the photographing environment obtained by the AF processing and AE processing by referring to the table.

Image processing unit 23 performs correction processing on digital image data obtained by imaging unit 21A, 21B for correcting variations in the sensitivity distributions of the image data and distortions of the optical systems and parallelizing processing for parallelizing the two images. The unit further performs image processing on the parallelized images, such as white balance adjustment, tone correction, sharpness correction, color correction, and the like. Note that reference symbols G1, G2 used for the base image and reference image before subjected to the processing of image processing unit 23 will also be used for the processed images.

Compression/expansion processing unit 24 performs compression, for example, in JPEG compression format or the like on image data representing base image G1 and reference image G2 processed by image processing unit 23 to generate an image file of distance image together with image data representing a distance image generated in a manner to be described later. That is, the image file includes the image data of base image G1, reference image G2, and the distance image. A header that includes auxiliary information, such as date and time of imaging and the like, is attached to the image file based on Exif format or the like.

When generating an image file, it is assumed in the present embodiment that a photographer may select whether or not to quantize and encode image data of a distance image, that is, ON/OFF of distance image conversion mode through input/output unit 37. Here, input/output unit 37 includes various interfaces, and user operable switches and buttons.

Frame memory 25 is a work memory used when various types of processing, including the processing of image processing unit 23, are performed on the image data representing base image G1 and reference image G2 obtained by imaging units 21A, 21B.

Media control unit 26 gains access to recording medium 29 and controls read/write operations for the image file of distance image.

Internal memory 27 has stored therein various constants to be set in distance measuring system 1, programs to be executed by CPU 36, and the like.

Display control unit 28 causes image data stored in frame memory 25 or an image recorded in recording medium 29 to be displayed on monitor 20.

Distance measuring system 1 further includes stereo matching unit 30, distance image generation unit 31, distance image conversion unit 32, distance image encoding unit 33, distance image reverse conversion unit 34, and distance image decoding unit 35.

Stereo matching unit 30 searches on reference image G2 for a point corresponding to a point on base image G1 based on the fact that a plurality of points, such as points P1, P2, P3, and so on, is present in real space along a visual line from point O1 which is projected to pixel Pa on base image G1 and pixel Pa′ on reference image G2 corresponding to pixel Pa is present on a straight line (epipolar line) representing projected images P1, P2, P3, and so on, as illustrated in FIG. 3. In FIG. 3, point O1 is a viewpoint of imaging unit 21A serving as a base camera and point O2 is a viewpoint of imaging unit 21B serving as a reference camera. Here, the viewpoints are the focal points of optical systems of imaging units 21A, 21B. When searching for corresponding points, it is preferable that base image G1 and reference image G2 subjected to the correction and parallelizing processing but not yet subjected to image processing be used, although the images subjected to image processing may also be used. Hereinafter, description will be made of a case in which base image G1 and reference image G2 not yet subjected to the image processing are used in the search for corresponding points.

More specifically, when searching for corresponding points, stereo matching unit 30 moves predetermined correlation window W along the epipolar line to calculate the correlation between pixels in the correlation windows W on base image G1 and reference image G2 at each moved position, and determines the center pixel of correlation window W on reference image G2 at a position where the correlation value in reference image G2 is larger than or equal to a predetermined threshold value as the corresponding point corresponding to pixel Pa in base image G1. As for the correlation evaluation value for evaluating the correlation, the sum of absolute differences, the reciprocal value of the sum of squared differences, or the like may be used. In this case, a smaller correlation evaluation value represents a larger correlation.

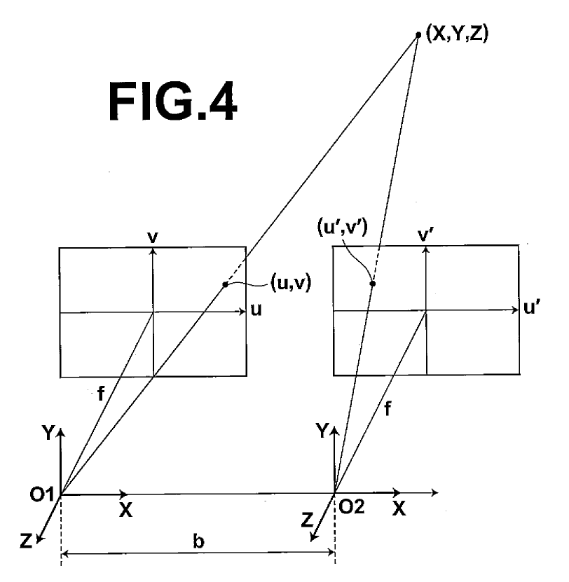

FIG. 4 illustrates the positional relationship between a base image and a reference image after parallelizing processing. As illustrated in FIG. 4, the origin of image planes, which are planes in imaging units 21A, 21B where base image G1 and reference image G2 are obtained, is the intersecting point between the optical axes of imaging units 21A, 21B. Coordinate systems of imaging units 21A, 21B on the image planes are defined as (u, v) and (u′, v′) respectively. Here, the optical axes of imaging units 21A, 21B become parallel to each other by the parallelizing processing, so that u-axis and u′-axis in the imaging planes are oriented in the same direction on the same straight line. Further, the epipolar line on reference image G2 becomes parallel to u′-axis by the parallelizing processing, so that u-axis on reference image G1 corresponds to the direction of the epipolar line on reference image G2.

Here, the focal length of imaging units 21A, 21B is assumed to be f, and the baseline length to be b. The focal length f and baseline length b are calculated in advance as calibration parameters and stored in internal memory 27. In this case, a position (X, Y, Z) in three-dimensional space is represented by Formulae (1) to (3) below when the coordinate system of imaging unit 21A is used as the base.

X=b·u/(u-u′) (1)

Y=b·v/(u-u′) (2)

Z=b·f/(u-u′) (3)

where, u-u′ is the shifted amount in the horizontal direction (parallax) between projected points on the image planes of imaging units 21A, 21B. Formula (3) indicates that distance Z that represents the depth is inversely proportional to the parallax. X, Y, and Z calculated in the manner as described above are referred to as the distance values. Distance values X, Y are positional information indicating the position of the pixel, and distance value Z is the distance, i.e., depth information. Note that distance values X, Y, and Z are calculated in an area common to base image G1 and reference image G2. Therefore, distance values X, Y, and Z are converted from the values in the coordinate system of imaging unit 21A to the values in a coordinate system with its origin at the intermediate position between the origins of image planes of imaging units 21A, 21B in order to facilitate the subsequent processing. Hereinafter, the description will be made on the assumption that the referent of coordinate system means the coordinate system with its origin at the intermediate position between the origins of image planes of imaging units 21A, 21B.

Distance image generation unit 31 calculates distance values X, Y, and Z by Formulae (1) to (3) above using the corresponding point obtained by stereo matching unit 30, and generates image data of distance images with calculated distance values X, Y, and Z as the pixel value of each image. Here, distance value Z of each pixel of the distance images represents the distances from imaging units 21A, 21B to the subject.

When the distance image conversion mode is set to ON by the photographer, distance image conversion unit 32 performs conversion processing in which the amount of data of a distance image with distance values X, Y, Z as the pixel value of each pixel is reduced by nonlinear processing. For this purpose, distance values X, Y, Z are quantized. In addition, distance image encoding unit 33 encodes image data of a distance image with distance values X, Y, Z converted by distance image conversion unit 32 as the pixel value of each pixel to generate image data of an encoded distance image. Hereinafter, processing performed by distance image conversion unit 32 and distance image encoding unit 33 will be described.

Each of distance values X, Y, Z calculated by distance image generation unit 31 is represented by, for example, 32 bit data. Accordingly, if the data are directly used as the image data of the distance image, the amount of data of the image file becomes very large. In this case, the amount of data may be reduced by quantizing each of distance values X, Y, Z from 32 bits to, for example, 8 bits, but the quantization results in degraded accuracy of the distance.

Here, distance value Z calculated by distance image generation unit 31 is more accurate if it is closer to imaging units 21A, 21B. Consequently, in the first embodiment, distance image conversion unit 32 sets a larger quantization allocation, i.e., quantization number to smaller distance value Z when performing quantization. In the first embodiment, distance image conversion unit 32 quantizes distance value Z so as to be represented by 8 bits. Here, an arrangement may be adopted in which the quantization bit number is set to a value desired by the photographer, such as 8 bits, 10 bits, 16 bits, or the like, by the input through the input/output unit 37. Further, distance values X, Y are also quantized so as to be represented by 8 bits respectively. Here also, an arrangement may be adopted in which the quantization bit number is set to a value desired by the photographer, such as 10 bits, 16 bits, or the like, by the input through the input/output unit 37, as in distance value Z.

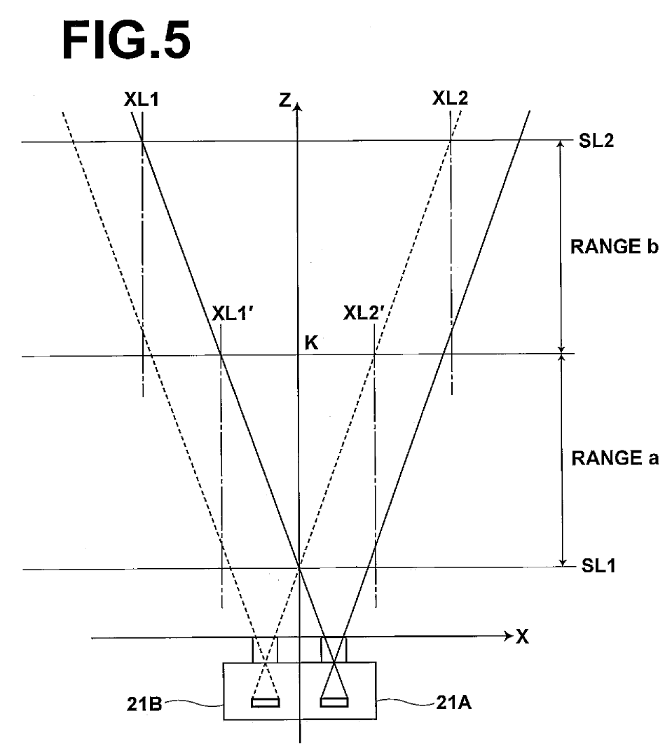

FIG. 5 illustrates allocation of quantization number. Note that FIG. 5 illustrates photographing field angles of imaging units 21A, 21B viewed from Y-axis direction. In FIG. 5, SL1 represents a shortest distance measurable by distance measuring system 1, SL2 represents a longest distance measurable by distance measuring system 1, K represents a reference distance serving as the basis for changing the quantization number, XL1 and XL2 define a range of a distance image in X-axis direction at longest distance SL2, and XL1′ and XL2′ define a range of the distance image in X-axis direction at reference distance K. The field angle of imaging unit 21A is represented by solid lines and the field angle of imaging unit 21B is represented by dashed lines. Although not shown, with respect to Y-axis direction perpendicular to the surface of the drawing, a range of the distance image defined by YL1 and YL2 in Y-axis direction at longest distance SL2 and a range of the distance image defined by YL1′ and YL2′ in Y-axis direction at reference distance K are also set. The range from distance SL1 to reference distance k is referred to as range a, and the range from reference distance to distance sL2 is referred to as range b. Note that these values are stored in internal memory 27 as setting values. Here, an arrangement may be adopted in which reference distance K is set to a desired value by the photographer using the input/output unit 37.

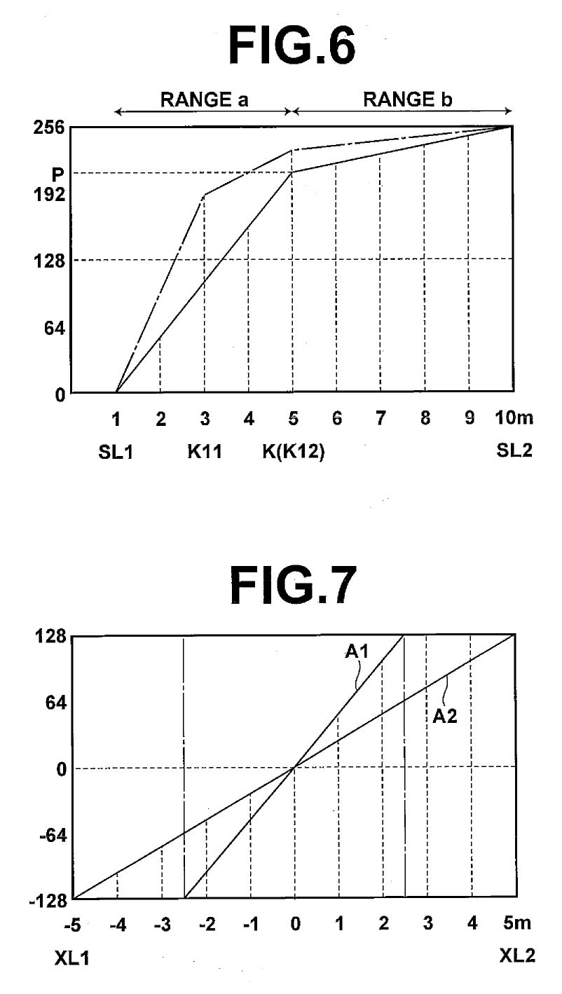

FIG. 6 illustrates the relationship between distance value Z calculated by distance image generation unit 31 and distance value Zti obtained by quantization in the first embodiment. In FIG. 6, SL1=1 m and SL2=10 m. As illustrated in FIG. 6, in the present invention, 5 m which is ½ of longest distance SL2 is used as reference distance K, and quantization value P at reference distance K is set to about 200 out of 8 bits. Distance image conversion unit 32 quantizes distance value Z in range a by allocating quantization value P thereto and distance value Z in range b by allocating quantization value 256-P using this relationship. This results in that smaller distance value Z is quantized with a larger quantization number. Here, the reason that reference distance K is set to ½ of longest distance SL2 is that the distance calculation accuracy is degraded at a rapid rate if it exceeds ½ of longest distance SL2.

In the first embodiment, distance image conversion unit 32 also quantizes distance values X, Y calculated by Formulae (1) and (2) above so as to become 8 bits respectively. FIG. 7 illustrates the relationship between distance value X and distance value Xti obtained by quantization. Here, the description will be made on the assumption that XL1=−5 m and XL2=5 m with Z-axis shown in FIG. 5 as the center. In range a, possible values of distance value X are from −2.5 to 2.5 m, so that distance image conversion unit 32 quantizes such that the values from 2.5 to 2.5 m are allocated to 8 bits in the manner as illustrated by relationship A1 in FIG. 7. While in range b, possible values of distance value X are from −5 to 5 m, so that distance image conversion unit 32 quantizes such that the values from −5 to 5 m are allocated to 8 bits in the manner as illustrated by relationship A2 in FIG. 7. Distance value Y is also quantized in the same manner as in distance value X.

Distance image encoding unit 22 encodes image data of a distance image with distance values X, Y, Z quantized by distance image conversion unit 32 as the pixel value of each pixel, and outputs the image data of the encoded distance image to compression/expansion processing unit 24.

Distance image decoding unit 35 decodes image data of the encoded distance image included in an image file generated by compression/expansion processing unit 24, as will be described later. Further, distance image reverse conversion unit 34 converts each pixel value of the distance image decoded by distance image decoding unit 35, which is reverse to the conversion of distance image conversion unit 32 (reverse conversion). Processing performed by distance image decoding unit 35 and distance image reverse conversion unit 34 will be described later.

CPU 36 controls each unit of distance measuring system 1 according to signals from input/output unit 37 that includes the release button.

Data bus 38 connects each unit of distance measuring system 1 and CPU 36 and various types of data and information in distance measuring system 1 are exchanged through the bus.

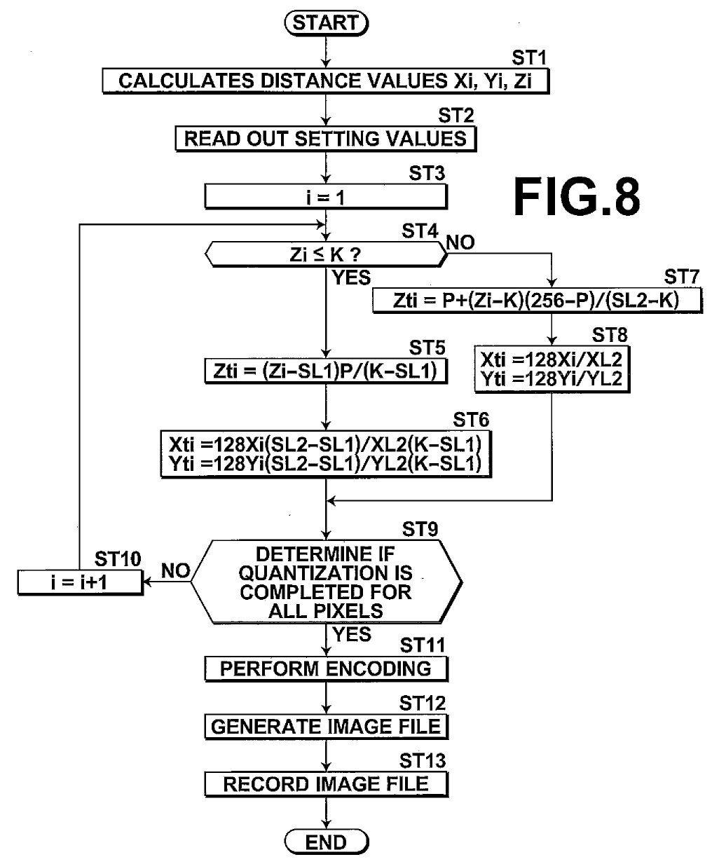

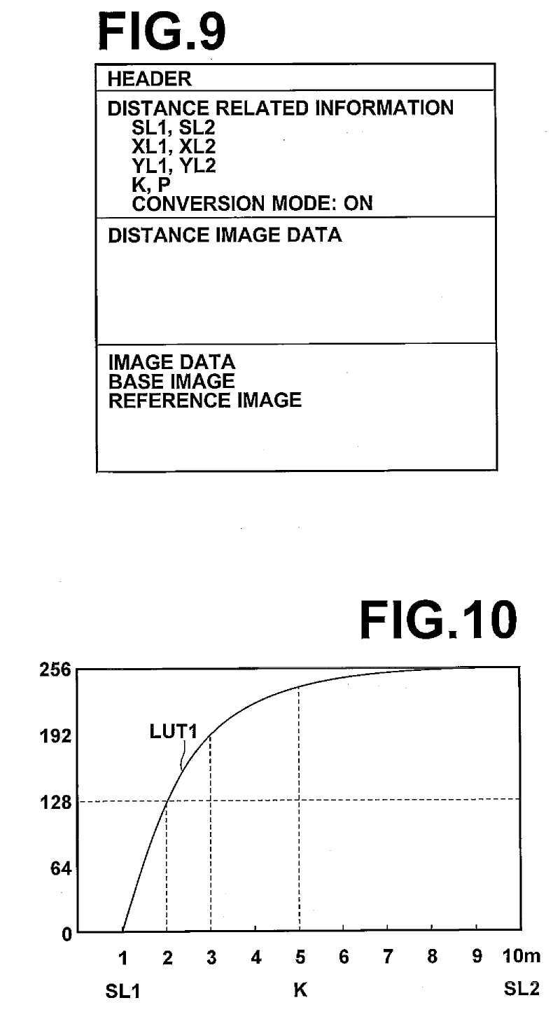

Processing performed in the first embodiment will now be described. FIG. 8 is a flowchart illustrating the processing performed in the first embodiment. Here, it is assumed that the conversion mode for compressing a distance image is set to ON. Further, processing following an instruction to start imaging is issued by fully depressing the release button will be described here. For distance values X, Y, Z calculated by distance image generation unit 31 are given a symbol “i” for identifying the pixel position thereof. Although the pixel position on a distance image is two-dimensional, but represented one-dimensionally in order to simplify the description.

CPU 36 starts the processing when the release button is fully depressed, and imaging units 21A, 21B photograph a subject in response to an instruction from CPU 36, then image processing unit 23 performs correction processing, parallelizing processing and image processing on the obtained image data to obtain base image G1 and reference image G2, stereo matching unit 30 searches for corresponding points, and distance image generation unit 31 calculates distance values Xi, Yi, Zi based on the searched out corresponding points (step ST1). Then, distance image conversion unit 32 reads out setting values from internal memory 27 (step ST2), and selects a first pixel as the quantization target pixel (i=1, step ST3).

Then, distance image conversion unit 32 determines whether or not distance value Zi is not larger than reference distance K (step ST4). If step ST4 is positive, distance image conversion unit 32 quantizes distance value Zi by Formula (4) below, which represents the relationship of range a in FIG. 6, to calculate quantized distance value Zti (step ST5). The unit further quantizes distance values Xi, Yi respectively by Formulae (5) and (6) below to calculate quantized distance values Xti, Yti (step ST6).

Zti=(Zi−SL1)×P/(K−SL1) (4)

Xti=128Xi(SL2−SL1)/XL2(K−SL1) (5)

Yti=128Yi(SL2−SL1)/YL2(K−SL1) (6)

If step ST4 is negative, distance image conversion unit 32 quantizes distance value Zi by Formula (7) below, which represents the relationship of range b in FIG. 6, to calculate quantized distance value Zti (step ST7). The unit further quantizes distance values Xi, Yi respectively by Formulae (8) and (9) below to calculate quantized distance values Xti, Yti (step ST8).

Zti=P+(Zi−K)(256−P)/(SL2−K1) (7)

Xti=128Xi/XL2 (8)

Yti=128Yi/YL2 (9)

Following step ST6 or step ST8, distance image conversion unit 32 determines whether or not the quantization of distance values Xi, Yi, Zi is completed for all pixels (step ST9). If step ST9 is negative, the next pixel is selected as the quantization target pixel (i=i+1, step ST10), and the processing returns to step ST4 to repeat the steps from step ST4 onward.

If step ST9 is positive, distance image encoding unit 33 encodes image data of the distance image with quantized distance values Xti, Yti, Zti as the pixel value of each pixel to generate image data of an encoded distance image (step ST11), and compression/expansion processing unit 24 generates an image file of a distance image from image data of base image G1 and reference image G2, and image data of the encoded distance image (step ST12). Then, in response to an instruction from CPU 36, media control unit 26 records the image file on recording medium 29 (step ST13), and the processing is terminated. In this case, the setting values read out from internal memory 27 as distance related information, i.e., SL1, SL2, XL1, XL2, YL1, YL2, K, and P are described in the header of the image file. Further, conversion mode ON/OFF information is also described in the header. Note that information other than the distance related information, such as the date and time of photographing and the like, is omitted here.

As described above, in the first embodiment, quantization is performed such that the smaller the distance value Zi the larger the quantization number. Here, when calculating a distance value from base image G1 and reference image G2, the calculation accuracy is degraded more for larger distance value Zi. According to the first embodiment, distance value Zi is quantized with a larger quantization number for smaller distance value Zi, so that the amount of data of the image file of the distance image may be reduced efficiently without degrading distance accuracy for relatively small distance value Zi.

In the first embodiment, the range of distance value Zi may be divided into three or more sections instead of two sections and a larger quantization number is used for smaller distance value Zi. For example, two reference distances K11, K12 may be set as illustrated by a dash-dot line in FIG. 6 and the quantization number for distance value Zi may be set by dividing the range into three sections, SL1 to K11, K11 to K12, and K12 to SL2. In this case, a reference distance according to the division of the range of distance value Zi is described in the header of the image file as distance related information.

Next, a second embodiment of the present invention will be described. A distance measuring system according to the second embodiment has a configuration identical to that of the distance measuring system 1 according to the first embodiment, and differs only in the processing performed by distance image conversion unit 32. Therefore, the configuration will not be elaborated upon further here. In the first embodiment, distance value Zi is quantized with a larger quantization number for smaller distance value Zi based on reference distance K and quantization value P at reference distanced, as illustrated in FIG. 6. The second embodiment differs from the first embodiment in that it provides conversion table LUT1 in internal memory 27 which represents that the smaller the distance value Zi, the smaller will become the quantization number logarithmically and continuously, as illustrated in FIG. 10, and quantizes distance value Zi using conversion table LUT1.

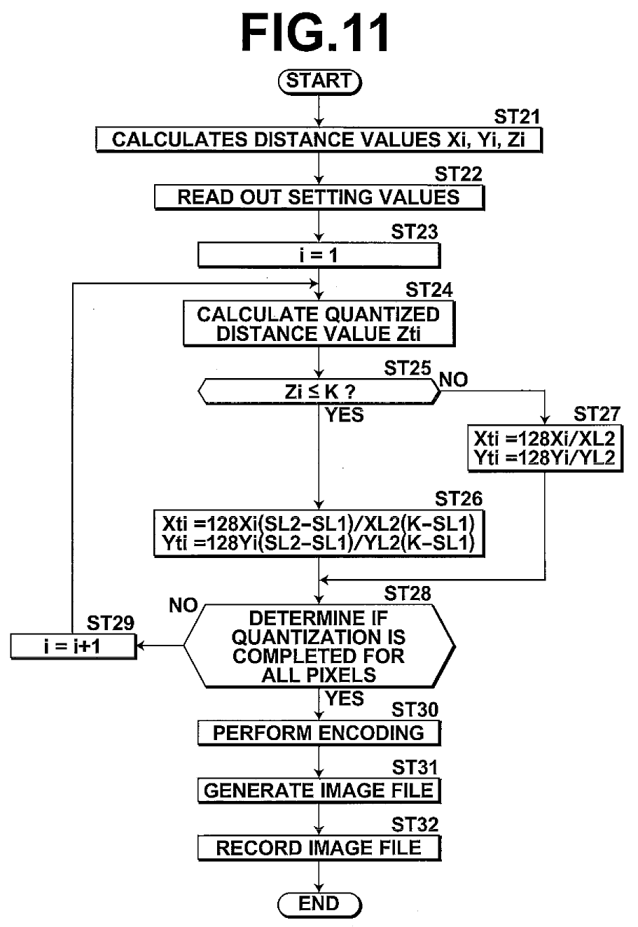

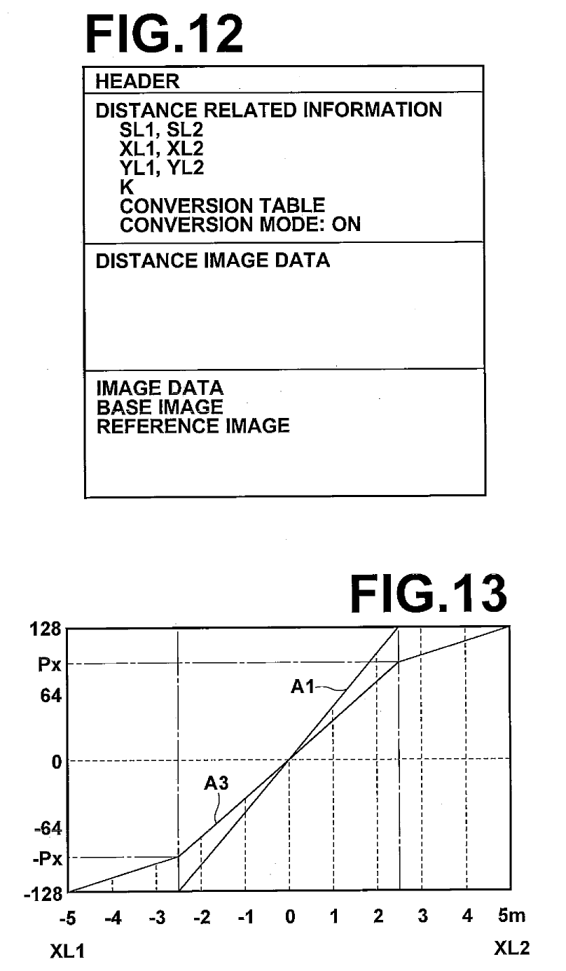

Next, processing performed in the second embodiment will be described. FIG. 11 is a flowchart illustrating the processing performed in the second embodiment. As in the first embodiment, distance image generation unit 31 calculates distance values Xi, Yi, Zi (step ST21). Then, distance image conversion unit 32 reads out setting values from internal memory 27 (step ST22), and selects a first pixel as the quantization target pixel (i=1, step ST23).

Then, distance image conversion unit 32 quantizes distance value Zi with reference to conversion table LUT1 to calculate quantized distance value Zti (step ST24). Then unit 32 determines whether or not distance value Zi is not larger than reference distance K (step ST25). If step ST25 is positive, unit 32 further distance values Xi, Yi respectively by Formulae (5) and (6) to calculate quantized distance values Xti, Yti as in the first embodiment (step ST26).

If step ST25 is negative, distance image conversion unit 32 quantizes distance values Xi, Yi respectively by Formulae (8) and (9) to calculate quantized distance values Xti, Yti (step ST27).

Following step ST26 or step ST27, distance image conversion unit 32 determines whether or not the quantization of distance values Xi, Yi, Zi is completed for all pixels (step ST28). If step ST28 is negative, the next pixel is selected as the quantization target pixel (i=i+1, step ST29), and the processing returns to step ST24 to repeat steps from step ST24 onward.

If step ST28 is positive, distance image encoding unit 33 encodes image data of the distance image with quantized distance values Xti, Yti, Zti as the pixel value of each pixel to generate image data of an encoded distance image (step ST30), and compression/expansion processing unit 24 generates an image file of a distance image from image data of base image G1 and reference image G2, and image data of the encoded distance image (step ST31). Then, in response to an instruction from CPU 36, media control unit 26 records the image file on recording medium 29 (step ST32), and the processing is terminated.

In this case, the setting values read out from internal memory 27 as distance related information, i.e., SL1, SL2, XL1, XL2, YL1, YL2, K, and conversion table are described in the header of the image file. Further, conversion mode ON/OFF information is also described in the header.

Here, in the first and second embodiments, where distance value Zi is greater than reference distance K, distance values Xi, Yi are uniformly quantized so as to be represented by 8 bits. Distance accuracy is higher in a position closer to the center of a distance image because of less distortion of the lenses of imaging units 21A, 21B and less influence of shading. Therefore, where distance value Zi is grater than reference distance K, distance values Xi, Yi may be quantized with a larger quantization number for those closer to Z-axis, which will be described as a third embodiment of the present invention below.

FIG. 13 illustrates the relationship between distance value X and distance value Xti obtained by quantization in the third embodiment. As in the first embodiment, SL1=1 m, SL2=10 m, K=5 m, XL1=−5 m, and XL2=5 m in FIG. 13. In range a, possible values of distance value X are from XL1/2 to XL2/2, that is, from −2.5 to 2.5 m, so that distance image conversion unit 32 quantizes the values so as to be represented by 8 bits in the manner as illustrated by relationship A1 in FIG. 13, as in the first and second embodiments. While in range b, possible values of distance value X are from −5 to 5 m, so that distance image conversion unit 32 quantizes such that the quantization number in the range from −2.5 to 2.5 m becomes larger than that in the range from −5 to −2.5 m and in the range from 2.5 to 5 m, as illustrated by relationship A3 in FIG. 13. For distance value Yi, quantization is performed in the same manner as that in the first and second embodiments in range a, and in range b, quantization is performed with a larger quantization number for distance value Yi closer to Z-axis, as in distance value Xi.

Here, it is assumed that quantization values ±Px, ±Py (FIG. 13 shows only ±Px) for changing the quantization number at reference distance K is stored in internal memory 27 in order to quantize distance values Xi, Yi. An arrangement may be adopted in which the quantization value and boundary for changing the quantization number are arbitrarily set by the photographer.

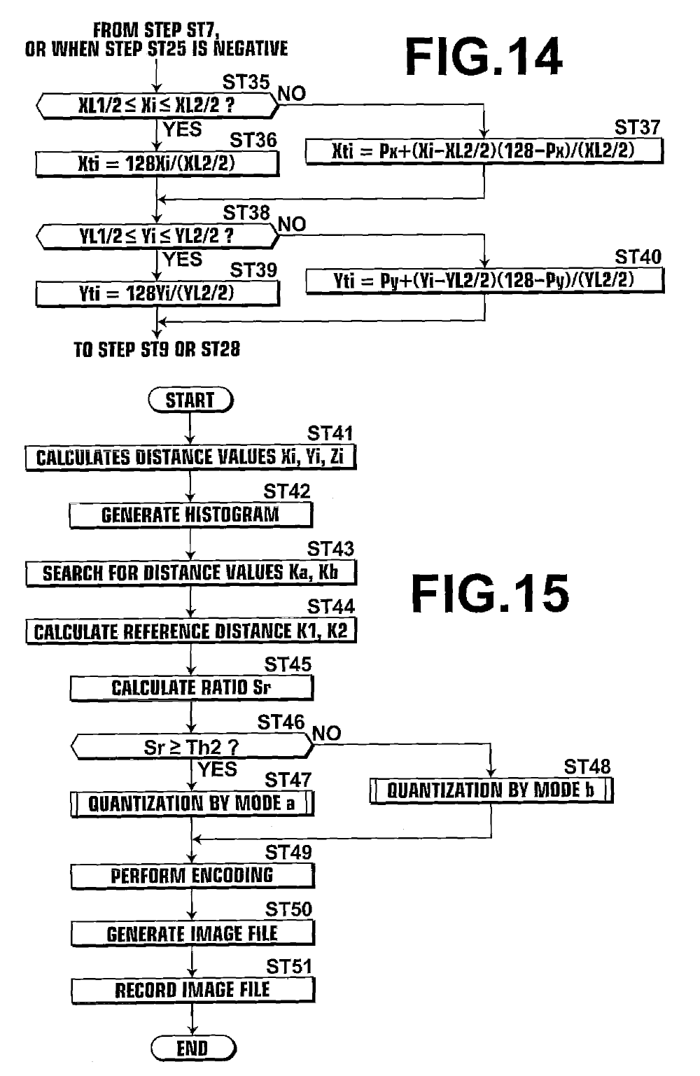

Next, processing performed in the third embodiment will be described. FIG. 14 is a flowchart illustrating the processing performed in the third embodiment. Quantization of distance values Xi, Yi in the third embodiment is performed following step ST7 in the first embodiment, or when step ST25 in the second embodiment is negative, so that only the processing following step ST7 or processing when step ST25 is negative will be described here.

Following step ST7, or when step ST25 is negative, distance image conversion unit 32 determines whether or not distance value X1 is XL1/2≦Xi≦XL2/2 (step ST35). If step ST35 is positive, unit 32 quantizes distance value Xi by Formula (10) below, which represents the relationship in the range XL1/2≦Xi≦XL2/2 in relationship A3 in FIG. 13, to calculate quantized distance value Zti (step ST36). If step ST35 is negative, unit 32 quantizes distance value Xi by Formula (11) below, which represents the relationship in the range Xi<XL1/2, and XL2/2<Xi in relationship A3 in FIG. 13, to calculate quantized distance value Zti (step ST37).

Xti=128Xi/(XL2/2) (10)

Xti=Px+(Xi−XL2/2)(128−Px)/(XL2/2) (11)

Following step ST36 or step ST37, distance image conversion unit 32 determines whether or not distance value Yi is YL1/2≦Yi≦YL2/2 (step ST38). If step ST38 is positive, unit 32 quantizes distance value Yi by Formula (12) below, which represents the relationship in the range YL1/2≦Yi≦YL2/2, to calculate quantized distance value Yti (step ST39). If step ST38 is negative, unit 32 quantizes distance value Xi by Formula (11) below, which represents the relationship in the range Yi<YL1/2, and YL2/2<Yi, to calculate quantized distance value Yti (step ST40).

Yti=128Yi/(YL2/2) (12)

Yti=Px+(Yi−YL2/2)(128−Px)/(YL2/2) (13)

Then the processing proceeds to step ST9 in the first embodiment or step ST28 in the second embodiment. This encodes image data of the distance image with quantized distance values Xti, Yti as the pixel value of each pixel, and an image file of the distance image is generated, then the image file is recorded on recording medium 29. In this case, values of ±Px, ±Py and the boundary for changing the quantization number are described in the header of the file as distance related information. Here, distance accuracy is higher in a position closer to the center of a distance image because of less distortion of the lenses of imaging units 21A, 21B and less influence of shading. In the third embodiment, a larger quantization number is used for distance values Xi, Yi closer to the center of the optical axis, so that the amount of data of image file of a distance image may further efficiently reduced without degrading distance accuracy adjacent to the center of the distance image.

In the third embodiment, the ranges of distance values Xi, Yi in which the quantization number is increased is symmetrical with respect to Z-axis in the X and Y directions. The reason is that the distortions and shading of the lenses of imaging unit 21A, 21B appear symmetrically. Note that the ranges of distance values Xi, Yi in which the quantization number is increased may be set asymmetrically with respect to Z-axis.

Next, a fourth embodiment of the present invention will be described. A distance measuring system according to the fourth embodiment has a configuration identical to that of the distance measuring system 1 according to the first embodiment, and differs only in the processing performed by distance image conversion unit 32. Therefore, the configuration will not be elaborated upon further here. The fourth embodiment differs from the first embodiment in that a distance range in which a target subject is present is determined based on distance value Zi, and distance value Zi in the distance range is quantized with a larger quantization number than that of distance value Zi in the other distance range.

Next, processing performed in the fourth embodiment will be described. FIG. 15 is a flowchart illustrating the processing performed in the fourth embodiment. As in the first embodiment, distance image generation unit 31 calculates distance values Xi, Yi, Zi (step ST41). Then, distance image conversion unit 32 generates a histogram in which distance value Zi is plotted on the horizontal axis and frequency is plotted on the vertical axis (step ST42).

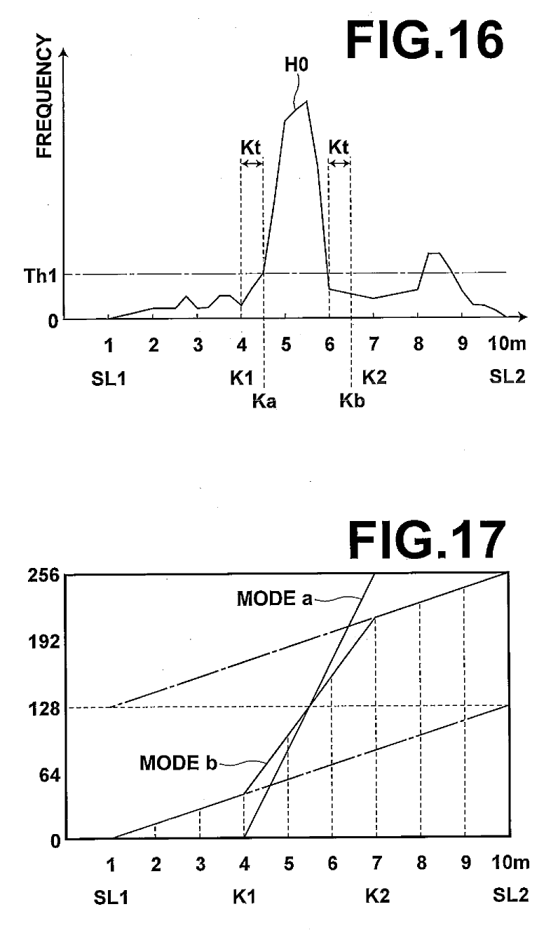

FIG. 16 illustrate distance histogram H0. As illustrated in FIG. 16, the frequency of a specific range where the subject is present becomes large in distance histogram H0.

Then, the distance image conversion unit 32 searches for distance Ka where the frequency changes to a value larger than threshold value Th1 and distance Kb where the frequency changes to a value less than threshold value Th1 in distance histogram H0 from the side of smaller distance value Zi (step ST43). Then, unit 32 calculates reference distances K1, K2 that define the distance range of the subject by subtracting 10% of the difference between Kb and Ka (Kt=0.1 (Kb−Ka)) from distance Ka and adding it to distance Kb (Ka−Kt, Kb+Kt) (step ST44).

Following step ST44, distance image conversion unit 32 calculates frequency Tu of distance value Zi in the range between reference distances K1, K2, and frequency Td of distance value Zi outside of the range, and further calculates ratio Sr (=Tu/Td) (step ST45). Then unit 32 determines whether or not ratio Sr is larger than or equal to predetermined threshold value Th2 (step ST46). Here, if ratio Sr is larger than or equal to threshold Th2, many distance values Zi are present in the range between reference distances K1, K2, while if ratio Sr is smaller than threshold value Th2, distance values Zi are widely distributed from SL1 to SL2.

Consequently, in the fourth embodiment, if ratio Sr is larger than or equal to threshold value Th2, distance image conversion unit 32 quantizes only distance values Zi in the range between reference distances K1, K2 so as to be represented by 8 bits, does not allocate quantization number to distance values Zi outside of the range, as illustrated in the relationship represented by mode a in FIG. 17. On the other hand, if ratio Sr is less than threshold value Th2, the unit 32 allocates a larger quantization number to distance value Zi in the range between reference ranges K1, K2 than that to distance value Zi outside of the range, as illustrated in the relationship represented by mode b in FIG. 17. In FIG. 17, reference distance K1=4 m and reference distance K2=7 m.

Accordingly, distance image conversion unit 32 performs quantization by mode a if step ST46 is positive (step ST47), and by mode b if step ST46 is negative (step ST48).

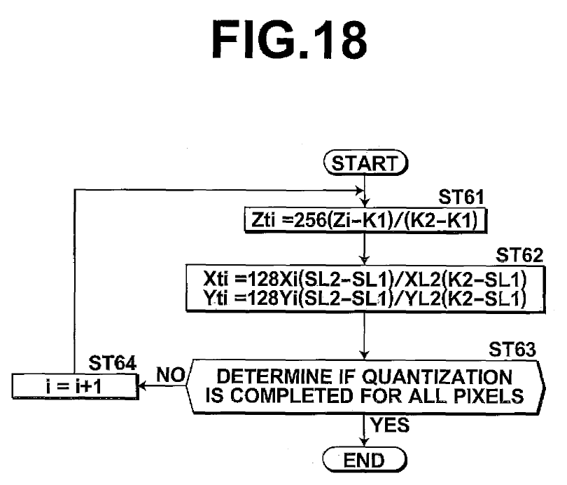

FIG. 18 is a flowchart illustrating quantization processing by mode a. In the case of quantization processing by mode a, distance image conversion unit 32 quantizes distance value Zi by Formula (14) below, which represents the relationship of mode a to obtain quantized distance value Zti (step ST61). Unit 32 further quantizes distance values Xi, Yi by Formulae (15) and (16) below respectively to obtain quantized distance values Xti, Yti (step ST 62).

Zti=256(Zi−K1)/(K2−K1) (14)

Xti=128Xi(SL2−SL1)/XL2(K2−SL1) (15)

Yti=128Yi(SL2−SL1)/YL2(K2−SL1) (16)

Then, distance image conversion unit 32 determines whether or not the quantization of distance values is completed for all pixels (step ST63). If step ST63 is negative, the next pixel is selected as the quantization target pixel (i=i+1, step ST64), and processing returns to step ST61 to repeat the steps from step ST61 onward. If step ST63 is positive, the quantization processing by mode a is terminated.

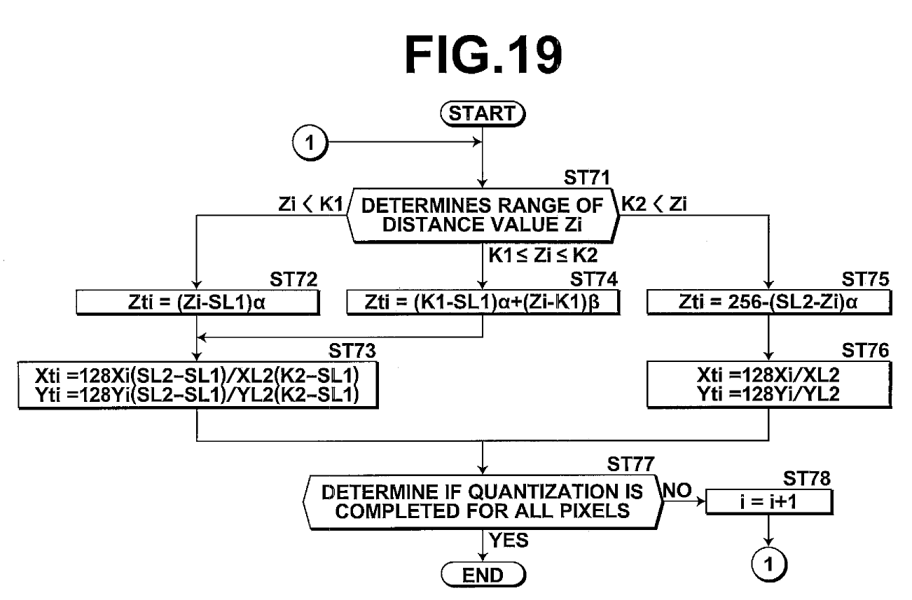

FIG. 19 is a flowchart illustrating quantization processing by mode b. In the case of quantization processing by mode b, distance image conversion unit 32 determines first the range of distance value Zi (step ST71). If Zi<K1, unit 32 quantizes distance value Zi by Formula (17) below, which represents the relationship in Zi<K1 of mode b in FIG. 17, to calculate quantized distance value Zti (step ST72). With respect to distance values Xi and Yi, unit 32 performs quantization by Formulae (15) and (16) above respectively to calculate quantized distance values Xti and Yti (step ST73).

Zti=(Zi−SL1)α (17)

where α=128/(SL2−SL1).

If K1≦Zi≦K2, distance image conversion unit 32 quantizes distance value Zi by Formula (18) below, which represents the relationship in K1≦Zi≦K2 of mode b in FIG. 17, to calculate quantized distance value Zi (step ST74). With respect to distance values Xi, Yi, the quantization processing proceeds to step ST73, and distance image conversion unit 32 performs quantization by Formulae (15) and (16) above respectively to calculate quantized distance values Xti and Yti.

Zti=(K1−K2)+(Zi−K1)β (18)

where β={256−(SL2−K2) α−(K1−SL1) α}/(K2−K1).

In the mean time, if K2<Zi, the distance image conversion unit 32 quantizes distance value Zi by Formula (19) below, which represents the relationship in K2<Zi of mode b in FIG. 17, to calculates quantized distance value zti (step ST75). With respect to distance values Xi, Yi, unit 32 performs quantization by Formulae (20) and (21) below respectively to calculate quantized distance values Xti, and Yti (step ST76).

Zti=256−(SL2−Zi)α (19)

Xti=128Xi/XL2 (20)

Yti=128Yi/YL2 (21)

Then, distance image conversion unit 32 determines whether or not the quantization of distance values is completed for all pixels (step ST77). If step ST77 is negative, the next pixel is selected as the quantization target pixel (i=i+1, step ST78), and processing returns to step ST71 to repeat the steps from step ST71 onward. If step ST77 is positive, the quantization processing by mode b is terminated.

Returning to FIG. 15, following step ST47 or step ST48, distance image encoding unit 33 encodes image data of the distance image with quantized distance values Xti, Yti, Zti as the pixel value of each pixel to generate image data of an encoded distance image (step ST49), and compression/expansion processing unit 24 generates an image file of a distance image from image data of base image G1 and reference image G2, and image data of the encoded distance image (step ST50). Then, in response to an instruction from CPU 36, media control unit 26 records the image file on recording medium 29 (step ST51), and the processing is terminated. In this case, the setting values read out from internal memory 27 as distance related information, i.e., SL1, SL2, XL1, XL2, YL1, YL2, K1, K2, and mode a or b are described in the header of the image file. Further, conversion mode ON/OFF information is also described in the header.

As described above, in the fourth embodiment, distance value Zi in a predetermined distance range is quantized with a larger quantization number than that of distance value Zi outside of the distance range. Here, when photographing a subject, it is often the case that the subject is present in a certain distance range. Consequently, the amount of data of an image file of a distance image may be reduced efficiently without degrading distance accuracy in a predetermined distance range.

In the fourth embodiment, reference distances K1, K2 are calculated by calculating distance histogram H0, but an arrangement may be adopted in which the quantization number is changed using reference distances K1, K2 set by the photographer without calculating distance histogram H0. In this case, reference distances K1, K2 may be obtained from an empirical distance range where a subject is often found. Further, quantization mode a or b may be set by the photographer. When mode a is set, in particular, distance values Xi, Yi, Zi need to be calculated only in the range from K1 to K2, so that calculation time may be reduced.

Further, in the fourth embodiment, an arrangement may be adopted in which the quantization number with respect to distance values Xi, Yi is changed according to the distance from Z-axis, as in the third embodiment.

Next, a fifth embodiment of the present invention will be described. A distance measuring system according to the fifth embodiment has a configuration identical to that of the distance measuring system 1 according to the first embodiment, and differs only in the processing performed by distance image conversion unit 32. Therefore, the configuration will not be elaborated upon further here. The fifth embodiment differs from the first embodiment in that a plurality of methods for quantizing distance values Xi, Yi, Zi is predetermined and one of the predetermined methods is selected by the photographer and quantization of distance values Xi, Yi, Zi is performed by the selected quantization method.

Here, the following methods may be selectable for quantizing distance value Zi. Namely, quantization-off that does perform quantization, method 1 that performs quantization by changing the quantization number in the manner as illustrated by the solid line in FIG. 6, method 2 that performs quantization by changing the quantization number in the manner as illustrated by the dash-dot line in FIG. 6, method 3 that performs quantization by changing the quantization number using LUT1 shown in FIG. 10, method 4 that performs quantization by mode a shown in FIG. 17, method 5 that performs quantization by mode b shown in FIG. 17, method 6 that determines a subject range based on a distance histogram with respect to method 4, and method 7 that determines a subject range based on a distance histogram with respect to method 5. It is not necessary to make all of the seven methods selectable, and a plurality of arbitrary methods of them may be made selectable.

As for quantization method of distance values Xi, Yi, the following methods may be made selectable. Namely, quantization-off that does perform quantization, method 11 that performs quantization by changing the quantization number based on relationship A1 and relationship A2 shown in FIG. 7, and method 12 that performs quantization by changing the quantization number based on relationship A1 and relationship A3 shown in FIG. 13.

Selection of the quantization method of distance values Xi, Yi, Zi may be made in the manner in which a quantization method selection screen is displayed on monitor 20 and a desired method is selected by the photographer from the displayed methods using input/output unit 37.

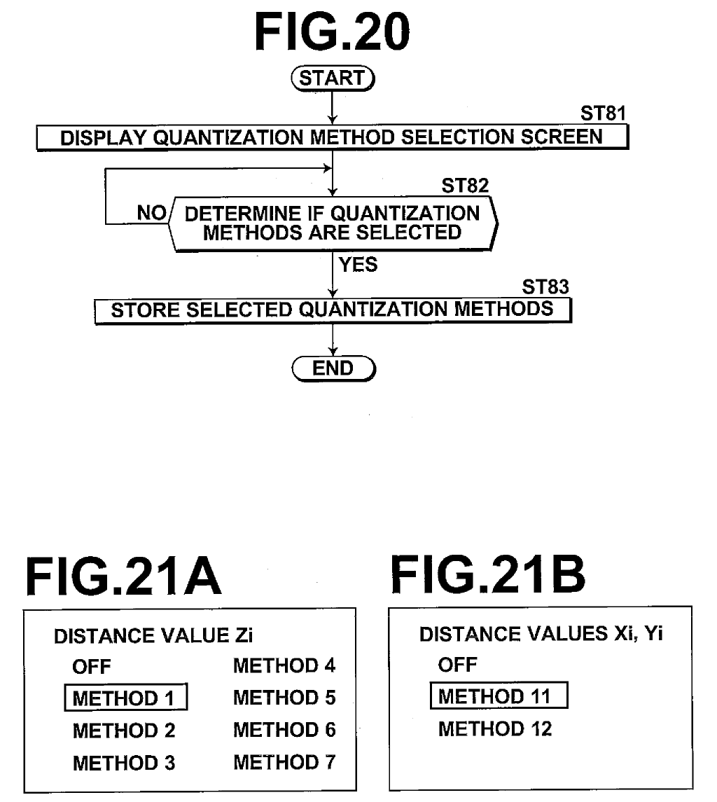

Next, processing performed in the fifth embodiment will be described. FIG. 20 is a flowchart illustrating quantization method selection processing performed in the fifth embodiment. CPU 36 starts the processing when an instruction to select a quantization method is received from the photographer, and displays a quantization method selection screen on monitor 20 (step ST81). FIGS. 21A, 21B illustrate quantization method selection screens. As illustrated in FIG. 21A, with respect to distance value Zi, quantization-off and methods 1 to 7 are displayed on monitor 21A. The photographer may select a desired quantization method for distance value Zi using input/output unit 37. FIG. 21A illustrates the case in which method 1 is selected. After quantization method for distance value Zi is selected, a quantization method selection screen for distance values Xi, Yi is displayed on monitor 20 as illustrated in FIG. 21B. The photographer may select a desired quantization method for distance values Xi, Yi using input/output unit 37. FIG. 21B illustrates the case in which method 11 is selected.

CPU 36 starts monitoring whether or not quantization methods are selected (step ST82). If step ST82 is positive, CPU 36 stores information representing the selected quantization methods in internal memory 27 (step ST83) and the processing is terminated.

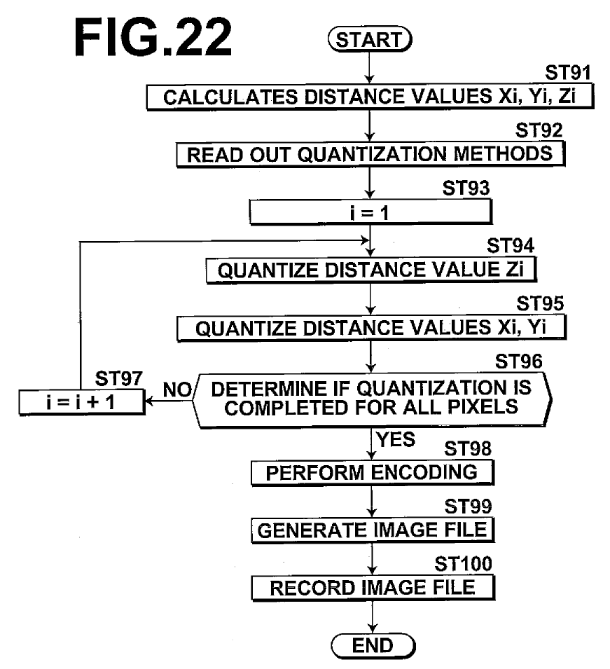

FIG. 22 is a flowchart illustrating processing performed in the fifth embodiment. First, distance image generation unit 31 calculates distance values Xi, Yi, Zi, as in the first embodiment (step ST91). Then, distance image conversion unit 32 reads out the quantization methods for distance values Xi, Yi, Zi from internal memory 27 (step ST92), selects a first pixel as the quantization target pixel (step ST93), and quantizes distance value Zi first by the readout quantization method (step ST94). Then, distance image conversion unit 32 quantizes distance values Xi, Yi by the readout quantization method (step ST95). Following step ST95, distance image conversion unit 32 determines whether or not the quantization of distance values Xi, Yi, Zi is completed for all pixels (step ST96). If step ST96 is negative, the next pixel is selected as the quantization target pixel (i=i+1, step ST97), and the processing returns to step ST94 to repeat the steps from step ST94 onward.

If step ST96 is positive, distance image encoding unit 33 encodes image data of the distance image with quantized distance values Xti, Yti, Zti as the pixel value of each pixel to generate image data of an encoded distance image (step ST98), and compression/expansion processing unit 24 generates an image file of a distance image from image data of base image G1 and reference image G2, and image data of the encoded distance image (step ST99). Then, in response to an instruction from CPU 36, media control unit 26 records the image file on recording medium 29 (step ST100), and the processing is terminated. In the fifth embodiment, the conversion method selected by the photographer is described in the header of the image file as distance related information.

As described above, in the fifth embodiment, the quantization methods for distance values Xi, Yi, Zi are made selectable, so that the photographer may convert distance values Xi, Yi, Zi by desired quantization methods.

In the fifth embodiment, the quantization method is selectable for distance values Xi, Yi, Zi, but an arrangement may be adopted in which the quantization method is selectable only for distance value Zi, or otherwise only for distance values Xi, Yi.

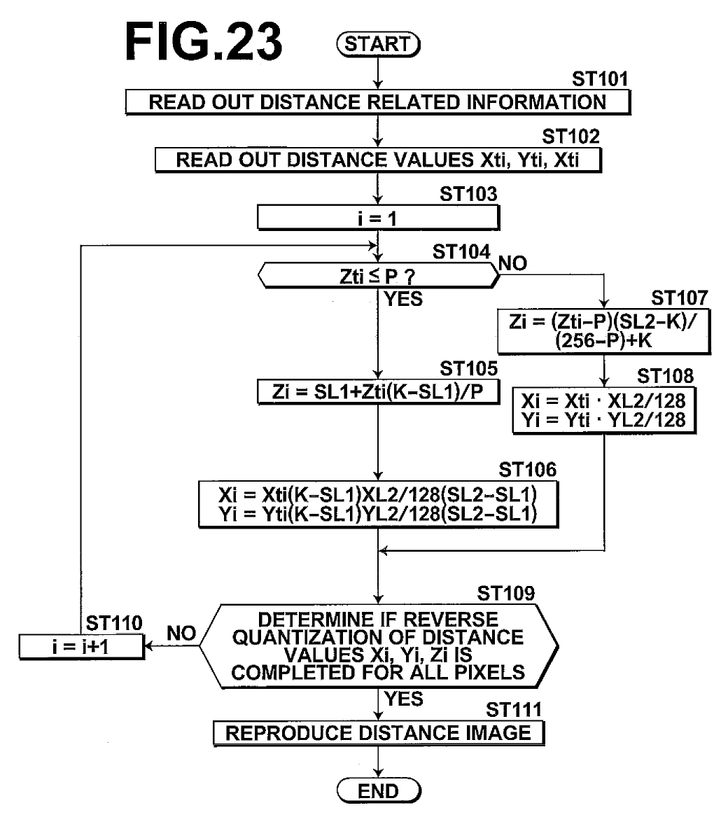

In the mean time, the image file generated in each of the first to fifth embodiment is decoded by distance image decoding unit 35 and further subjected to reverse conversion including inverse quantization in distance image reverse conversion unit 34, whereby the distance image is reproduced. FIG. 23 is a flowchart illustrating inverse quantization processing for the image file. Here, it is assumed that the image file generated by the first embodiment is already decoded by distance image decoding unit 35 and decoded distance values Xi, Yi, Zi are ready to be read out from frame memory 25. Further, it is assumed that setting values SL1, SL2, XL1, XL2, YL1, YL2, K, P and conversion mode ON are described in the header of the image file as distance related information.

Distance image reverse conversion unit 34 reads out the distance related information from the header of the decoded image file (step ST101), and further reads out decoded distance values Xti, Yti, Zti (step ST102). Then unit 34 selects a first pixel as the target pixel for calculating distance values Xi, Yi, Zi (i=1, step ST103), and determines whether or not distance value Zti is smaller than or equal to quantization value P (step ST104).

If step ST104 is positive, the distance image reverse conversion unit 34 calculates distance value Zi by Formula (21) below, which represents the reverse relationship of range a in FIG. 6, using the distance related information (step ST105). Further, unit 34 calculates distance values Xi, Yi by Formulae (22), (23) below (step ST106). Formulae (21), (22), (23) may be obtained by solving Formulae (4), (5), (6) above for Zi, Xi, Yi respectively.

Zi=SL1+Zti(K−SL1)/P (21)

Xi=Xti(K−SL1)XL2/128(SL2−SL1) (22)

Yi=Yti(K−SL1)YL2/128(SL2−SL1) (23)

In the mean time, if step ST104 is negative, distance image reverse conversion unit 34 calculates distance value Zi by Formula (24) below, which represents the reverse relationship of range b in FIG. 6, using the distance related information (step ST107). Further, unit 34 calculates distance values Xi, Yi by Formulae (25), (26) below (step ST108). Formulae (24), (25), (26) may be obtained by solving Formulae (7), (8), (9) above for Zi, Xi, Yi respectively.

Zi=(Zti−P)(SL2−K)/(256−P)+K (24)

Xi=Xti·XL2/128 (25)

Yi=Yti·YL″/128 (26)

Following step ST106 or step ST108, distance image reverse conversion unit 34 determines whether or not the inverse quantization of distance values Xi, Yi, Zi is completed for all pixels (step ST109). If step ST109 is negative, the next pixel is selected as the inverse quantization target pixel (i=i+1, step ST110), and the processing returns to step ST104 to repeat the steps from step ST104 onward.

If step ST109 is positive, display control unit 28 reproduces a distance image with distance values Xi, Yi, Zi as the pixel value of each pixel on monitor 20 (step ST111), and the processing is terminated.

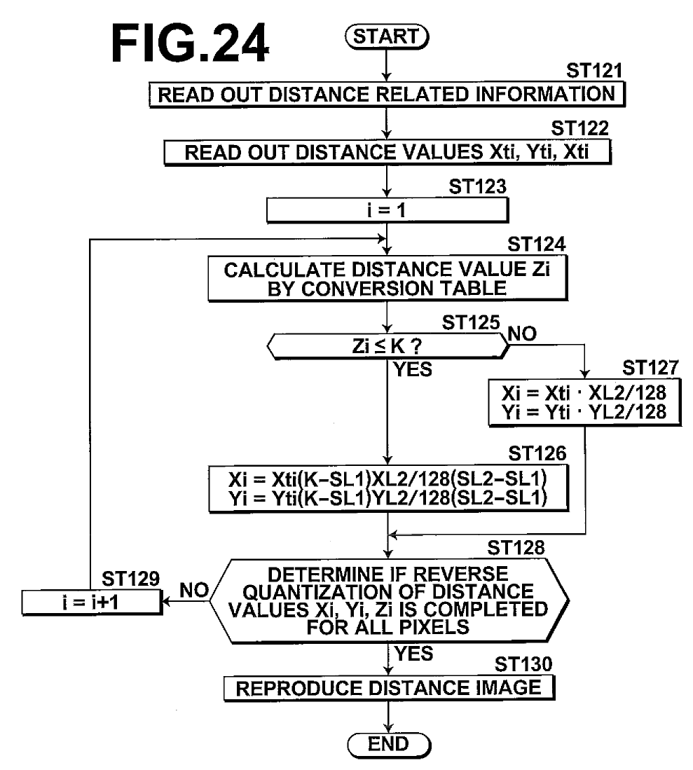

For the image file generated by the second embodiment, inverse quantization is performed in the following manner. FIG. 24 is a flowchart illustrating inverse quantization processing for the image file generated by the second embodiment. Here, it is it is assumed that the image file generated by the second embodiment is already decoded by distance image decoding unit 35 and decoded distance values Xi, Yi, Zi are ready to be read out from frame memory 25. Further, it is assumed that setting values SL1, SL2, XL1, XL2, YL1, YL2, K, conversion table and conversion mode ON are described in the header of the image file as distance related information.

Distance image reverse conversion unit 34 reads out the distance related information including the conversion table from the header of the decoded image file (step ST121), and further reads out decoded distance values Xti, Yti, Zti (step ST122). Then unit 34 selects a first pixel as the target pixel for calculating distance values Xi, Yi, Zi (i=1, step ST123), and calculates distance value zi from distance value Zti using the conversion table (step ST124). Then, unit 34 determines whether or not distance value Zi is smaller than or equal to reference distance K (step ST125).

If step ST125 is positive, distance image reverse conversion unit 34 calculates distance values Xi, Yi by Formulae (22), (23) above using the distance related information (step ST126). If step ST125 is negative, distance image reverse conversion unit 34 calculates distance values Xi, Yi by Formulae (25), (26) above (step ST127). Following step ST126 or step ST127, distance image reverse conversion unit 34 determines whether or not the inverse quantization of distance values Xi, Yi, Zi is completed for all pixels (step ST128). If step ST128 is negative, the next pixel is selected as the inverse quantization target pixel (i=i+1, step ST129), and the processing returns to step ST124 to repeat the steps from step ST124 onward.

If step ST128 is positive, display control unit 28 reproduces a distance image with distance values Xi, Yi, Zi as the pixel value of each pixel on monitor 20 (step ST130), and the processing is terminated.

For the image file generated by the third embodiment, where distance value Zti is larger than quantization number P or distance value Zi is larger than reference distance K, a determination is made as to whether or not −Px≦Xti≦Px. If the determination is positive, distance value Xi is calculated by the formula obtained by solving Formula (10) for Xi, and if the determination is negative, distance value Xi is calculated by the formula obtained by solving Formula (11) for Xi. For distance value Yi, a determination is made as to whether or not −Py≦Yti≦Py. If the determination is positive, distance value Yi is calculated by the formula obtained by solving Formula (12) for Yi, and if the determination is negative, distance value Yi is calculated by the formula obtained by solving Formula (13) for Yi.

For the image file generated by the fourth embodiment, where mode a is described in the header, distance values Zi, Xi, Yi are calculated by the formulae obtained by solving Formulae (14), (15), (16) for Zi, Xi, Yi respectively. Where mode b is described in the header, if Zti≦K1, distance values Xi, Yi, Zi are calculated by the formulae obtained by solving Formulae (17), (15), (16) for Zi, Xi, Yi respectively, if K1≦Zti≦K2, distance values Xi, Yi, Zi are calculated by the formulae obtained by solving Formulae (18), (15), (16) for Zi, Xi, Yi respectively, and if K2≦Zti, distance values Xi, Yi, Zi are calculated by the formulae obtained by solving Formulae (19), (15), (16) for Zi, Xi, Yi respectively.

For the image file generated by the fifth embodiment, the inverse quantization processing is performed according to the conversion method described in the header.

In each of the embodiments described above, image file of the distance image is generated in distance measuring system 1, but a configuration may be adopted in which distance image conversion unit 32 and distance image encoding unit 33 are provided outside of system 1, and image data of base image G1 and reference image G2 are outputted to the external distance image conversion unit 32 and distance image encoding unit 33 to perform the conversion and encoding of distance values Xi, Yi, Zi. Further, a configuration may be adopted in which distance image reverse conversion unit 34 and distance image decoding unit 35 are provided outside of system 1, and the image file of the distance image is outputted to the external distance image reverse conversion unit 34 and distance image decoding unit 35 to perform the decoding and reverse conversion of the image file.

Further, in each of the embodiments described above, the reference distance may be set according to the distance to a subject. For example, in each of the embodiments described above, photographing is performed by fixing the focal position. But an arrangement may be adopted in which AF processing is performed and the reference distance is set according to the focal length obtained by the AF processing with the assumption that the focal length is the distance to a subject. For example, when the subject distance value according to the focal length is Fd, reference distance K11 and reference distance K12 shown in FIG. 6 are set to Fd+1.0 m and K11+1.0 m respectively, reference distance K shown in FIG. 10 is set to Fd+1.0 m, and reference distance K1 and reference distance K2 shown in FIG. 17 are set to Fd−1.0 m and Fd+1.0 m respectively.

Still further, distance measuring system 1 may include a flash, a sensor for detecting the amount of flash light reflected from a subject, and a means for calculating the distance to the subject based on the amount of reflected light, thereby setting the reference distance according to the distance to the subject calculated by this.

Further, where distance measuring system 1 is provided with a function to set an imaging mode at the time of photographing, there may be a case in which the distance to the subject may be estimated based on the imaging mode. In such a case, the reference distance may be set according to the imaging mode. For example, when the imaging mode is set to macro mode for performing macro photographing, short-range photographing for a subject is performed. Therefore, reference distance K11 and reference distance K12 shown in FIG. 6 are set to 0.5 m and 1.0 m respectively, reference distance K shown in FIG. 10 is set 1.0 m, and reference distance K1 and reference distance K2 shown in FIG. 17 are set to 0.5 m and 1.0 m respectively. The reference distance according to the imaging mode may be stored in internal memory.

Further, in each of the embodiments described above, the distance image is generated in distance measuring system 1 using base image G1 and reference image G2 obtained by imaging units 21A, 21B, but a configuration may be adopted in which imaging units 21A, 21B are provided separately from system 1, and base image G1 and reference image G2 obtained by imaging units 21A, 21B are inputted to distance measuring system to generate an image file of the distance image is generated using inputted base image G1 and reference image G2.

Still further, in each of the embodiments described above, distance values Xi, Yi, Zi are calculated by a stereo matching method, but distance values Xi, Yi, Zi may be calculated by a TOF (Time of Flight) distance measuring method, in which the distance to a subject is measured by making use of the reflection of light. In this case, light emission unit for emitting distance measuring light, such as infrared light or the like, an imaging unit for receiving reflection light of the distance measuring light reflected by the subject, and distance value calculation unit for calculating a distance value by the phase difference between the measuring light and reflection light are provided in distance measuring system 1 in order to perform the TOF measuring method. In this case, distance value Zi is the distance value calculated by the distance value calculation unit, and distance values Xi, Yi are represented by the position of imaging element of the imaging unit.

Further, in each of the embodiments described above, an image file that includes image data of base image G1 and reference image G2, but an image file that includes only image data of the distance image may be generated. Further, base image G1 and reference image G2 are subjected to compression processing, but image data of base image G1 and reference image G2 may be included in the image file without being compressed.

In the embodiment of reverse conversion described above, the target reverse conversion image file is not limited to those generated in the first to fifth embodiments, and it may include any image file generated in any manner if it is an image file of a distance image in which distance values are converted by quantization and distance related information is attached thereto.

So far embodiments of the present invention have been described, but a program for causing a computer to function as means corresponding to stereo matching unit 30, distance image generation unit 31, distance image conversion unit 32, distance image encoding unit 33, distance image reverse conversion unit 34, and distance image decoding unit 35, thereby performing processing like that shown in FIGS. 8, 11, 14, 15, 18 to 20, and 22 to 24 is another embodiment of the present invention. Further, a computer readable recording medium on which is recorded such a program is still another embodiment of the present invention.

What is claimed is:

1. A distance image processing apparatus, comprising:
a distance value obtaining means for obtaining distance values that include depth information and position information, and represent a three-dimensional shape of a subject obtained by photographing the subject;
a conversion means for converting the depth information with a quantization number such that the smaller the depth information the larger the quantization number; and
an image file generation means for generating an image file of a distance image with distance values that include the converted depth information as the pixel value of each pixel, the image file including information related to the conversion attached thereto.

2. The distance image processing apparatus as claimed in claim 1, wherein the conversion means is a means that sets the quantization number to a larger value for depth information smaller than or equal to a first threshold value than a value for depth information exceeding the first threshold value.

3. The distance image processing apparatus as claimed in claim 2, wherein the conversion means is a means capable of setting the first threshold value.

4. The distance image processing apparatus as claimed in claim 3, wherein the conversion means is a means capable of setting the first threshold value according to distance information representing the distance to the subject.

5. The distance image processing apparatus as claimed in claim 2, wherein the image file generation means is a means that attaches information of the first threshold value and quantization number at the first threshold value to the image file as the information related to the conversion.

6. The distance image processing apparatus as claimed in claim 1, wherein the conversion means is a means that converts the depth information based on a predetermined continuously changing relationship between the depth information and quantization number.

7. The distance image processing apparatus as claimed in claim 5, wherein the image file generation means is a means that attaches information of the relationship to the image file as the information related to the conversion.

8. The distance image processing apparatus as claimed in claim 1, wherein the conversion means is a means capable of setting the quantization number for the depth information after converted.

9. The distance image processing apparatus as claimed in claim 1, wherein the conversion means is a means that accepts an instruction to convert the depth information and converts the depth information only when the instruction is given.

10. The distance image processing apparatus as claimed in claim 1, wherein when the depth information is larger than a second threshold value:
the conversion means is a means that converts the position information such that the closer the position information to the center of a distance image with the distance values as the pixel value of each pixel the larger the quantization number; and
the image file generation means is a means that generates an image file of a distance image with distance values that include the converted position information as the pixel value of each pixel.

11. The distance image processing apparatus as claimed in claim 10, wherein the conversion means is a means that sets the quantization number to a larger value for position information in a predetermined area of the distance image including the center thereof than a value for position information outside of the predetermined area.

12. The distance image processing apparatus as claimed in claim 10, wherein the image file generation means is a means that attaches information of the boundary of the predetermined area and quantization number at the boundary to the image file as the information related to the conversion.

13. The distance image processing apparatus as claimed in claim 10, wherein the conversion means is a means capable of setting the second threshold value.

14. The distance image processing apparatus as claimed in claim 13, wherein the conversion means is a means capable of setting the second threshold value according to distance information representing the distance to the subject.

15. The distance image processing apparatus as claimed in claim 10, wherein the conversion means is a means capable of setting the quantization number for the position information after converted.

16. The distance image processing apparatus as claimed in claim 10, wherein the conversion means is a means that accepts an instruction to convert the position information and converts the position information only when the instruction is given.

17. A distance image reproducing apparatus, comprising:
an image file obtaining means for obtaining an image file generated by the distance image processing apparatus as claimed in claim 1; and
a reverse conversion means for obtaining the information related to the conversion attached to the image file and reversely converting the converted depth information included in the image file based on the information.

18. A distance image reproducing apparatus, comprising:
an image file obtaining means for obtaining an image file generated by the distance image processing apparatus as claimed in claim 10; and
a reverse conversion means for obtaining the information related to the conversion attached to the image file and reversely converting the converted depth information and position information included in the image file based on the information.

19. A distance image processing method, comprising the steps of:
obtaining distance values that include depth information and position information, and represent a three-dimensional shape of a subject obtained by photographing the subject;
converting the depth information with a quantization number such that the smaller the depth information the larger the quantization number; and
generating an image file of a distance image with distance values that include the converted depth information as the pixel value of each pixel, the image file including information related to the conversion attached thereto.

20. The distance image processing method as claimed in claim 19, wherein when the depth information is larger than a second threshold value, the method comprises the steps of:
converting the position information such that the closer the position information to the center of a distance image with the distance values as the pixel value of each pixel the larger the quantization number; and
generating an image file of a distance image with distance values that include the converted position information as the pixel value of each pixel.

21. A distance image reproducing method comprising the steps of:
obtaining an image file generated by the distance image processing method as claimed in claim 19;
obtaining the information related to the conversion attached to the image file; and
reversely converting the converted depth information included in the image file based on the information.

22. A distance image reproducing method comprising the steps of:
obtaining an image file generated by the distance image processing method as claimed in claim 20;
obtaining the information related to the conversion attached to the image file; and
reversely converting the converted depth information and position information included in the image file based on the information.

23. A computer readable recording medium on which is recorded a program for causing a computer to perform a distance image processing method comprising the steps of:
obtaining distance values that include depth information and position information, and represent a three-dimensional shape of a subject obtained by photographing the subject;
converting the depth information with a quantization number such that the smaller the depth information the larger the quantization number; and
generating an image file of a distance image with distance values that include the converted depth information as the pixel value of each pixel, the image file including information related to the conversion attached thereto.

24. The computer readable recording medium as claimed in claim 23, wherein when the depth information is larger than a second threshold value, the method further comprises the steps of:
converting the position information such that the closer the position information to the center of a distance image with the distance values as the pixel value of each pixel the larger the quantization number; and
generating an image file of a distance image with distance values that include the converted position information as the pixel value of each pixel.

25. A computer readable recording medium on which is recorded a program for causing a computer to perform a distance image reproducing method comprising the steps of:
obtaining an image file generated by the distance image processing method as claimed in claim 19;
obtaining the information related to the conversion attached to the image file; and
reversely converting the converted depth information included in the image file based on the information.

26. A computer readable recording medium on which is recorded a program for causing a computer to perform a distance image reproducing method comprising the steps of:
obtaining an image file generated by the distance image processing method as claimed in claim 20;
obtaining the information related to the conversion attached to the image file; and
reversely converting the converted depth information and position information included in the image file based on the information.

27. A distance image processing apparatus, comprising:
a distance value obtaining means for obtaining distance values that include depth information and position information, and represent a three-dimensional shape of a subject obtained by photographing the subject;
a conversion means for converting, when the depth information is larger than a first threshold value, the position information with a quantization number such that the closer the position information to the center of a distance image with the distance values as the pixel value of each pixel the larger the quantization number; and
an image file generation means for generating an image file of a distance image formed of distance values that include the converted position information, the image file including information related to the conversion attached thereto.

28. The distance image processing apparatus as claimed in claim 27, wherein the conversion means is a means that sets the quantization number to a larger value for position information in a predetermined area of the distance image including the center thereof than a value for position information outside of the predetermined area.

29. The distance image processing apparatus as claimed in claim 27, wherein the image file generation means is a means that attaches information of the boundary of the predetermined area and quantization number at the boundary to the image file as the information related to the conversion.

30. The distance image processing apparatus as claimed in claim 27, wherein the conversion means is a means capable of setting the first threshold value.

31. The distance image processing apparatus as claimed in claim 30, wherein the conversion means is a means capable of setting the first threshold value according to distance information representing the distance to the subject.

32. The distance image processing apparatus as claimed in claim 27, wherein the conversion means is a means capable of setting the quantization number for the position information after converted.

33. The distance image processing apparatus as claimed in claim 27, wherein the conversion means is a means that accepts an instruction to convert the position information and converts the position information only when the instruction is given.

34. A distance image reproducing apparatus, comprising:
an image file obtaining means for obtaining an image file generated by the distance image processing apparatus as claimed in claim 27; and
a reverse conversion means for obtaining the information related to the conversion attached to the image file and reversely converting the converted position information included in the image file based on the information.

35. A distance image processing method, comprising the steps of:
obtaining distance values that include depth information and position information, and represent a three-dimensional shape of a subject obtained by photographing the subject;
converting, when the depth information is larger than a first threshold value, the position information with a quantization number such that the closer the position information to the center of a distance image with the distance values as the pixel value of each pixel the larger the quantization number; and
generating an image file of a distance image formed of distance values that include the converted position information.

36. A distance image reproducing method, comprising the steps of:
obtaining an image file generated by the distance image processing method as claimed in claim 35;
obtaining the information related to the conversion attached to the image file; and
reversely converting the converted position information included in the image file based on the information.

37. A computer readable recording medium on which is recorded a program for causing a computer to perform a distance image processing method comprising the steps of:
obtaining distance values that include depth information and position information, and represent a three-dimensional shape of a subject obtained by photographing the subject;
converting, when the depth information is larger than a first threshold value, the position information with a quantization number such that the closer the position information to the center of a distance image with the distance values as the pixel value of each pixel the larger the quantization number; and
generating an image file of a distance image formed of distance values that include the converted position information.

38. A computer readable recording medium on which is recorded a program for causing a computer to perform a distance image reproducing method comprising the steps of:
obtaining an image file generated by the distance image processing method as claimed in claim 35;
obtaining the information related to the conversion attached to the image file; and
reversely converting the converted position information included in the image file based on the information.

39. A distance image processing apparatus, comprising:
a distance value obtaining means for obtaining distance values that include depth information and position information, and represent a three-dimensional shape of a subject obtained by photographing the subject;
a conversion means for converting depth information in a predetermined range with a larger quantization number than that of depth information outside of the predetermined range; and
an image file generation means for generating an image file of a distance image with distance values that include the converted depth information as the pixel value of each pixel, the image file including information related to the conversion attached thereto.

40. The distance image processing apparatus as claimed in claim 39, wherein the conversion means is a means that generates a distance histogram representing frequency of the depth information in the depth direction and sets the predetermined range based on the distance histogram.

41. The distance image processing apparatus as claimed in claim 39, wherein the image file generation means is a means that attaches information of upper and lower limits of the predetermined range and quantization numbers at the upper and lower limits to the image file as the information related to the conversion.

42. The distance image processing apparatus as claimed in claim 39, wherein the conversion means is a means capable setting the quantization number of the depth information after converted.

43. The distance image processing apparatus as claimed in claim 39, wherein the conversion means is a means that accepts an instruction to convert the depth information and converts the depth information only when the instruction is given.

44. The distance image processing apparatus as claimed in claim 39, wherein when the depth information is larger than a first threshold value:
the conversion means is a means that converts the position information such that the closer the position information to the center of a distance image with the distance values as the pixel value of each pixel the larger the quantization number; and
the image file generation means is a means that generates an image file of a distance image with distance values that include the converted position information as the pixel value of each pixel.

45. The distance image processing apparatus as claimed in claim 44, wherein the conversion means is a means that sets the quantization number to a larger value for position information in a predetermined area of the distance image including the center thereof than a value for position information outside of the predetermined area.

46. The distance image processing apparatus as claimed in claim 44, wherein the image file generation means is a means that attaches information of the boundary of the predetermined area and quantization number at the boundary to the image file as the information related to the conversion.

47. The distance image processing apparatus as claimed in claim 44, wherein the conversion means is a means capable of setting the first threshold value.

48. The distance image processing apparatus as claimed in claim 47, wherein the conversion means is a means capable of setting the first threshold value according to distance information representing the distance to the subject.

49. The distance image processing apparatus as claimed in claim 44, wherein the conversion means is a means capable of setting the quantization number for the position information after converted.

50. The distance image processing apparatus as claimed in claim 44, wherein the conversion means is a means that accepts an instruction to convert the position information and converts the position information only when the instruction is given.

51. A distance image reproducing apparatus, comprising:
an image file obtaining means for obtaining an image file generated by the distance image processing apparatus as claimed in claim 39; and
a reverse conversion means for obtaining the information related to the conversion attached to the image file and reversely converting the converted depth information included in the image file based on the information.

52. A distance image reproducing apparatus, comprising:
an image file obtaining means for obtaining an image file generated by the distance image processing apparatus as claimed in claim 44; and
a reverse conversion means for obtaining the information related to the conversion attached to the image file and reversely converting the converted depth information and position information included in the image file based on the information.

53. A distance image processing method, comprising the steps of:
obtaining distance values that include depth information and position information, and represent a three-dimensional shape of a subject obtained by photographing the subject;
converting depth information in a predetermined range with a larger quantization number than that of depth information outside of the predetermined range; and
generating an image file of a distance image with distance values that include the converted depth information as the pixel value of each pixel, the image file including information related to the conversion attached thereto.

54. The distance image processing method as claimed in claim 53, wherein when the depth information is larger than a first threshold value, the method comprises the steps of:
converting the position information such that the closer the position information to the center of a distance image with the distance values as the pixel value of each pixel the larger the quantization number; and
generating an image file of a distance image with distance values that include the converted position information as the pixel value of each pixel.

55. A distance image reproducing method comprising the steps of:
obtaining an image file generated by the distance image processing method as claimed in claim 53;
obtaining the information related to the conversion attached to the image file; and
reversely converting the converted depth information included in the image file based on the information.

56. A distance image reproducing method comprising the steps of:
obtaining an image file generated by the distance image processing method as claimed in claim 54;
obtaining the information related to the conversion attached to the image file; and
reversely converting the converted depth information and position information included in the image file based on the information.

57. A computer readable recording medium on which is recorded a program for causing a computer to perform a distance image processing method comprising the steps of:
obtaining distance values that include depth information and position information, and represent a three-dimensional shape of a subject obtained by photographing the subject;
converting depth information in a predetermined range with a larger quantization number than that of depth information outside of the predetermined range; and
generating an image file of a distance image with distance values that include the converted depth information as the pixel value of each pixel, the image file including information related to the conversion attached thereto.

58. The computer readable recording medium as claimed in claim 57, wherein when the depth information is larger than a first threshold value, the method comprises the steps of:
converting the position information such that the closer the position information to the center of a distance image with the distance values as the pixel value of each pixel the larger the quantization number; and
generating an image file of a distance image with distance values that include the converted position information as the pixel value of each pixel.

59. A computer readable recording medium on which is recorded a program for causing a computer to perform a distance image reproducing method comprising the steps of:
obtaining an image file generated by the distance image processing method as claimed in claim 53;
obtaining the information related to the conversion attached to the image file; and
reversely converting the converted depth information included in the image file based on the information.

60. A computer readable recording medium on which is recorded a program for causing a computer to perform a distance image reproducing method comprising the steps of:
obtaining an image file generated by the distance image processing method as claimed in claim 54;
obtaining the information related to the conversion attached to the image file; and
reversely converting the converted depth information and position information included in the image file based on the information.

61. A distance image processing apparatus, comprising:
a distance value obtaining means for obtaining distance values that include depth information and position information, and represent a three-dimensional shape of a subject obtained by photographing the subject;
a conversion means for converting at least either of the depth information and position information by a selected one of a plurality of predetermined quantization methods; and
an image file generation means for generating an image file of a distance image with distance values that include at least either of the converted depth information and position information as the pixel value of each pixel, the image file including information related to the conversion attached thereto.

62. The distance image processing apparatus as claimed in claim 61, wherein the conversion means is a means that converts the depth information by a selected one of a plurality of quantization methods that quantizes the depth information with a quantization number such that the smaller the depth information the larger the quantization number.

63. The distance image processing apparatus as claimed in claim 61, wherein the conversion means is a means that converts the position information by a selected one of a plurality of quantization methods that quantizes the position information with a quantization number such that the closer the position information to the center of a distance image with the distance values as the pixel value of each pixel the larger the quantization number.

64. The distance image processing apparatus as claimed in claim 61, wherein the conversion means is a means that converts the depth information by a selected one of a plurality of quantization methods that quantizes depth information in a predetermined range with a larger quantization number than that of depth information outside of the predetermined range.

65. The distance image processing apparatus as claimed in claim 61, further comprising a selection means for accepting selection of a desired one of the plurality of quantization methods.

66. A distance image reproducing apparatus, comprising:
an image file obtaining means for obtaining an image file generated by the distance image processing apparatus as claimed in claim 61; and
a reverse conversion means for obtaining the information related to the conversion attached to the image file and reversely converting at least either of the converted depth information and position information included in the image file based on the information.

67. A distance image processing method, comprising the steps of:
obtaining distance values that include depth information and position information, and represent a three-dimensional shape of a subject obtained by photographing the subject;
converting at least either of the depth information and position information by a selected one of a plurality of predetermined quantization methods; and
generating an image file of a distance image with distance values that include at least either of the converted depth information and position information as the pixel value of each pixel, the image file including information related to the conversion attached thereto.

68. A distance image reproducing method, comprising the steps of:
obtaining an image file generated by the distance image processing apparatus as claimed in claim 64;
obtaining the information related to the conversion attached to the image file; and
reversely converting at least either of the converted depth information and position information included in the image file based on the information.

69. A computer readable recording medium on which is recorded a program for causing a computer to perform a distance image processing method comprising the steps of:
obtaining distance values that include depth information and position information, and represent a three-dimensional shape of a subject obtained by photographing the subject;
converting at least either of the depth information and position information by a selected one of a plurality of predetermined quantization methods; and
generating an image file of a distance image with distance values that include at least either of the converted depth information and position information as the pixel value of each pixel, the image file including information related to the conversion attached thereto.

70. A distance image reproducing apparatus, comprising:
an image file obtaining means for obtaining an image file of a distance image generated by converting distance values that include depth information and position information, and represent a three-dimensional shape of a subject such that the amount of data thereof is reduced, the distance image being formed with the distance values reduced in the amount of data as the pixel value of each pixel, and the image file including information related to the conversion attached thereto; and
a reverse conversion means for obtaining the information related to the conversion attached to the image file and reversely converting the distance values included in the image file based on the information.

71. The distance image reproducing apparatus as claimed in claim 70, wherein when the distance values are converted by quantizing at least either of the depth information and position information by a predetermined quantization method, the reverse conversion means is a means that reversely converts at least either of the converted depth information and position information included in the image file based on the information.

72. A distance image reproducing method, comprising the steps of:
obtaining an image file of a distance image generated by converting distance values that include depth information and position information, and represent a three-dimensional shape of a subject such that the amount of data thereof is reduced, the distance image being formed with the distance values reduced in the amount of data as the pixel value of each pixel, and the image file including information related to the conversion attached thereto;
obtaining the information related to the conversion attached to the image file; and
reversely converting the distance values included in the image file based on the information.

73. A computer readable recording medium on which is recorded a program for causing a computer to perform a distance image reproducing method comprising the steps of:
obtaining an image file of a distance image generated by converting distance values that include depth information and position information, and represent a three-dimensional shape of a subject such that the amount of data thereof is reduced, the distance image being formed with the distance values reduced in the amount of data as the pixel value of each pixel, and the image file including information related to the conversion attached thereto;
obtaining the information related to the conversion attached to the image file; and
reversely converting the distance values included in the image file based on the information.
